(19) United States
(12) Patent Application Publication
(10) Pub. No.: US 2024/0338157 A1
(43) Pub. Date: Oct. 10, 2024

(54) STORAGE MEDIUM, CONTROL METHOD FOR CONTROLLING INFORMATION PROCESSING APPARATUS, AND INFORMATION PROCESSING APPARATUS

(71) Applicant: CANON KABUSHIKI KAISHA, Tokyo (JP)

(72) Inventor: HIROTOMO TANAKA, Chiba (JP)

(21) Appl. No.: 18/628,388

(22) Filed: Apr. 5, 2024

(30) Foreign Application Priority Data
Apr. 10, 2023 (JP) 2023-063253

(51) Int. Cl. G06F 3/12

(52) U.S. Cl. CPC G06F 3/126; G06F 3/1204; G06F 3/1282

(57) ABSTRACT

A control method for controlling an information processing apparatus includes displaying sheet information, searching for an image forming apparatus to which sheet information selected by a user is able to be set, and displaying the image forming apparatus found by the search.

### BACKGROUND

### Field

The present disclosure relates to a storage medium, a control method for controlling an information processing apparatus, and an information processing apparatus.

### Description of the Related Art

In the production printing market, digital multifunction peripherals (hereinafter referred to as “image forming apparatuses”) including a wide variety of sheet feeding trays, such as a plurality of sheet feeding trays, a manual-bypass tray, and an inserter, are used. Sheet information is set to each sheet feeding tray of the image forming apparatus by a user via an operation panel of the image forming apparatus, and a sheet that matches the sheet information is loaded to each sheet feeding tray, whereby printing can be performed on the sheet desired by the user.

As described above, since an image forming apparatus in production printing has a plurality of sheet feeding trays and a wide variety of sheets are settable, a sheet management application for a sheet management setting is provided to the image forming apparatus as a technique for the operability enhancement.

For example, Japanese Patent Application Laid-Open No. 2018-122451 discusses a system where, with respect to a single image forming apparatus connected through a sheet management application, a sheet setting to a desired sheet feeding tray can be performed via a sheet list by a simple operation. In Japanese Patent Application Laid-Open No. 2018-122451, further, an administrator and a user are discriminated from each other, and the administrator logged into the sheet management application can enable a lock of a sheet feeding tray of the image forming apparatus. As for the sheet feeding tray locked by the administrator using the sheet management application, the user cannot change sheet information set to the sheet feeding tray. In production of print products using image forming apparatuses, the production efficiency generally decreases if sheets in sheet feeding trays are replaced on an ad-hoc basis. In many cases, a sheet to be frequently used and a sheet to be infrequently used are determined beforehand, and a sheet feeding tray for the sheet to be frequently used is fixed. However, there is still a case where the user loads, in the fixed sheet feeding tray, a sheet different from a sheet determined via an operation panel of an image forming apparatus, and performs printing. In the system of Japanese Patent Application Laid-Open No. 2018-122451, since the administrator can enable the lock of a sheet feeding tray via the sheet management application, it is possible to prevent the user from loading a sheet unintended by the administrator in the sheet feeding tray.

In general production printing environment, a plurality of image forming apparatuses (including not only different models but also different types of the same model) is installed and the administrator manages the plurality of apparatuses. In this environment, the operability and the efficiency are improved with using a single sheet management application with respect to the plurality of image forming apparatuses to enable various sheets to be settable to each sheet feeding tray by using the single sheet management application. However, the technique using a single sheet management application for management of sheet information on a single image forming apparatus is not for sheet management for a plurality of image forming apparatuses. If sheet management is individually performed in a plurality of image forming apparatuses by using a plurality of sheet management applications, there arises an issue that the user cannot centralize management of selection of an image forming apparatus in which a commercial sheet is to be used. There also arises an issue that the user referring to sheet information has difficulty in selecting an image forming apparatus capable of being used in printing from among the plurality of image forming apparatuses. There is a need among image forming apparatuses to share sheet list information and setting information on sheet feeding trays that are stored as unique information in the respective image forming apparatuses.

In production printing, an expensive sheet (e.g., paper using limestone) or a special sheet (e.g., magnetic paper, coated paper, or a long sheet) is sometimes used depending on the print product, such as a business card. An operation for such production printing is often performed after the administrator has determined an image forming apparatus to be used for the printing from among the plurality of image forming apparatuses in accordance with properties of each image forming apparatus (excellent in registration adjustment or making a print product less warped). For example, in the printing of a business card using expensive paper, a print product is cut after the printing, and thus, using an image forming apparatus excellent in front/back registration adjustment is desirable to obtain a final product of which the front and back are aligned. In a conventional technique, however, there is not a mechanism to impose limitations on use of an image forming apparatus in printing in accordance with sheet information. Thus, there can be a case where the user simply selects a frequently used image forming apparatus from among a plurality of image forming apparatuses to perform the printing without understanding the intention of the administrator.

As described above, in production printing, the user needs to understand the operation rule, of the image forming apparatuses in accordance with sheets, determined by the administrator, and determination of which of the image forming apparatuses can be used for a certain sheet in a particular printing is difficult to be made on the sheet management application. Further, with increase in the number of image forming apparatuses, the user further has difficulty in understanding the operation rule.

Sheet information registered in advance in image forming apparatuses differs from each other in accordance with the model of the image forming apparatus, and some models are in a state that, even if a grammage and a surface property of a sheet are within ranges supported by the image forming apparatus, sheet information on the sheet is not registered. Hardware (the diameter of a drum, the diameter of a curve of a sheet conveyance path, or the pressure of holding a sheet) may also vary by the type of the image forming apparatus, and a print product with significant curl or strong streaks may be obtained depending on initial settings of image forming apparatuses. In such a model, a sheet causing these defects is not recommended to be used, and sheet information on the sheet is not registered in the image forming apparatuses.

In a situation where a plurality of image forming apparatuses is installed, it is undesirable to rely on the user to memorize sheet information registered in each image forming apparatus. It is also unrealistic for the user to check sheet management applications each corresponding to a different one of the image forming apparatuses one by one. There can also be a case that, even with a sheet having a grammage and a surface property settable in an image forming apparatus, the user is unfamiliar with the image forming apparatus and places the sheet in a sheet feeding tray without setting the grammage and the surface property of the sheet to the image forming apparatus.

### SUMMARY

According to an aspect of the present disclosure, a control method for controlling an information processing apparatus includes displaying sheet information, searching for an image forming apparatus to which sheet information selected by a user is able to be set, and displaying the image forming apparatus found by the search.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration of a print management system according to an exemplary embodiment.

FIG. 2 is a block diagram illustrating a hardware configuration of an image forming apparatus according to the exemplary embodiment.

FIG. 3 is a block diagram illustrating a hardware configuration of a client computer according to the exemplary embodiment.

FIGS. 4A to 4C are diagrams illustrating examples of top screens of a sheet management application according to the exemplary embodiment.

FIG. 5 is a diagram illustrating an example of a connection destination input screen of the sheet management application according to the exemplary embodiment.

FIG. 6A is a flowchart of a sheet management application start process according to the exemplary embodiment. FIG. 6B is a flowchart of a connection printer addition process according to the exemplary embodiment.

FIG. 7A is a table illustrating sheet feeding tray setting information on a printer for the sheet management application according to the exemplary embodiment. FIG. 7B is a table illustrating sheet list information on the printer for the sheet management application according to the exemplary embodiment. FIG. 7C is a table illustrating sheet feeding tray list information on the printer for the sheet management application according to the exemplary embodiment.

FIGS. 8A to 8C are tables each illustrating common sheet list information and sheet information on the printer for the sheet management application according to the exemplary embodiment.

FIGS. 9A and 9B are diagrams each illustrating a management table that associates a sheet with a printer for the sheet management application according to the exemplary embodiment.

FIG. 10A is a flowchart illustrating a process of generating the common sheet list information by the sheet management application according to the exemplary embodiment. FIG. 10B is a flowchart illustrating a process of generating a table associating a printer with a sheet according to the exemplary embodiment.

FIG. 11A is a flowchart illustrating a printer response process of the printer according to the exemplary embodiment. FIG. 11B is a flowchart illustrating an information acquisition command process according to the exemplary embodiment.

FIGS. 12A and 12B are diagrams illustrating examples of sheet detailed information screens for the printer according to the exemplary embodiment.

FIG. 13A is a flowchart illustrating a procedure of display of sheet detailed information on the printer according to the exemplary embodiment. FIG. 13B is a flowchart illustrating a procedure of associating a sheet with a printer according to the exemplary embodiment.

FIG. 14A is a flowchart illustrating a process of assigning a sheet by the sheet management application according to the exemplary embodiment. FIG. 14B is a flowchart illustrating a procedure of searching for a printer to which a sheet is assignable based on the sheet according to the exemplary embodiment.

FIGS. 15A to 15C are tables each illustrating sheet list information and sheet information on a printer for a sheet management application according to another exemplary embodiment.

FIGS. 16A and 16B are diagrams illustrating examples of sheet setting screens for setting sheet information on a sheet feeding tray of the printer according to another exemplary embodiment.

FIG. 17 is a flowchart of a procedure of updating the sheet list information on the printer according to another exemplary embodiment.

FIG. 18A is a flowchart illustrating a procedure of display of a sheet feeding tray in the printer according to another exemplary embodiment. FIG. 18B is a flowchart illustrating a sheet type setting update process.

### DESCRIPTION OF THE EMBODIMENTS

Hereinafter, exemplary embodiments for carrying out the present disclosure will be described with reference to the drawings.

The following exemplary embodiments are not intended to limit the present disclosure according to the appended claims, and all combinations of features described in the exemplary embodiments are not necessarily mandatory to the means for solving the issues by the present disclosure.

### Overall Configuration of Print Management System

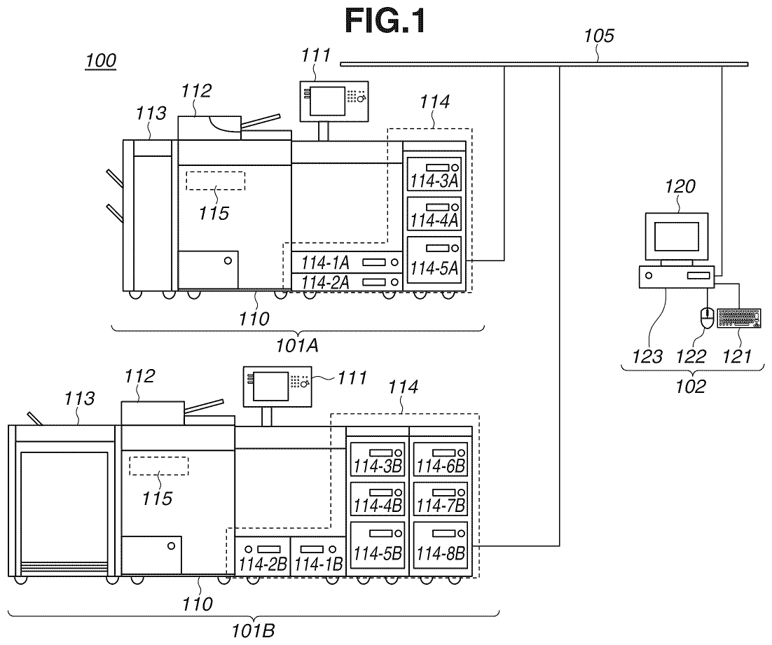

FIG. 1 is a diagram illustrating an overall configuration of a print management system 100 according to a first exemplary embodiment.

The print management system 100 includes image forming apparatuses 101A and 101B (hereinafter sometimes referred to collectively as an “image forming apparatus 101”) and a client computer 102 connected to the image forming apparatuses 101A and 101B so that the client computer 102 can communicate with the image forming apparatuses 101A and 101B.

The image forming apparatus 101 and the client computer 102 are connected together via a local area network (LAN) 105 by an Ethernet (registered trademark) cable so that the image forming apparatus 101 and the client computer 102 can communicate with each other.

The image forming apparatus 101 is a multifunction peripheral having a variety of functions. The image forming apparatus 101 executes printing based on data received from the client computer 102, copies image data read from a document, and transmits the image data to a shared folder. The image forming apparatus 101 receives an instruction from a sheet management application operating on the client computer 102 and executes necessary processing. While, in the present exemplary embodiment, the two image forming apparatuses 101A and 101B are connected to the LAN 105, a single image forming apparatus or a plurality of, i.e., three or more, image forming apparatuses can be connected to the LAN 105.

The client computer 102 starts the application according to an operation of a user, operates the print management system 100, and issues a print instruction from a printer driver.

### (Hardware Configuration of Image Forming Apparatus)

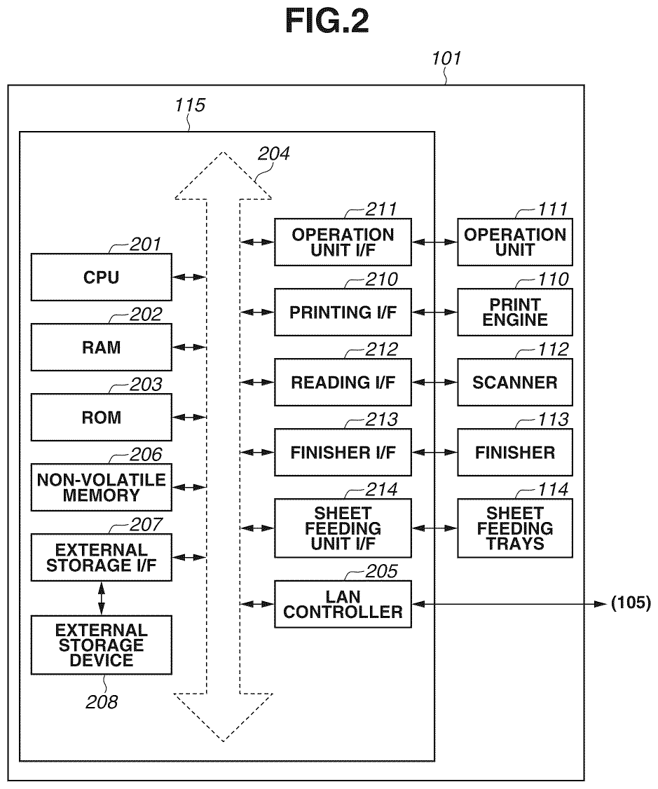

As illustrated in FIGS. 1 and 2, the image forming apparatus 101 includes an operation unit 111, a print engine 110, a scanner 112, a finisher 113, sheet feeding trays 114, and a controller 115. While the finisher 113 and the sheet feeding trays 114 in FIG. 1 are different in appearance and shape (the numbers of sheet discharge trays and sheet feeding trays and load capacity) between the image forming apparatus 101A and 101B, the basic modules of the finisher 113 and the sheet feeding trays 114 are the same.

The operation unit 111 is a panel that displays information to a user and receives an operation of the user. The operation unit 111 includes a display unit, such as a liquid crystal screen, and input units, such as a touch sensor and a hardware key. A central processing unit (CPU) 201 executes a program stored in an external storage device 208 and loaded into a random-access memory (RAM) 202, whereby an operation screen is displayed on the operation unit 111 and an input is received from the user.

The print engine 110 is an image forming processing unit that forms an image on a sheet. For example, the print engine 110 performs printing by an electrophotographic method to form an image and thermally fixes a toner image to a sheet. The print engine 110 may be an engine having another printing mechanism, such as an inkjet method.

The scanner 112 is a reading device that reads a document. The document is read through a pressure plate document platen or by an auto document feeder (ADF).

The finisher 113 is a post-processing device that performs post-processing on a sheet. For example, the finisher 113 performs a sorting process, a punching process, or a stapling process on a sheet conveyed from the print engine 110 and discharges the sheet to a predetermined location.

The sheet feeding trays 114 are sheet storage units that store sheets for use in image formation. Numbers are assigned to the respective sheet feeding trays 114, and information on the stored sheets is managed using the operation unit 111 and the sheet management application. In the present exemplary embodiment, for example, the image forming apparatus 101A includes five sheet feeding trays 114, and 114-1A to 114-5A are assigned to the sheet feeding trays 114 in this order.

The controller 115 is a control unit that performs overall control of the image forming apparatus 101.

### (Hardware Configuration of Controller)

FIG. 2 is a block diagram illustrating a hardware configuration of the image forming apparatus 101 and the controller 115 in the image forming apparatus 101.

The controller 115 includes the CPU 201, the RAM 202, a ROM 203, and a non-volatile memory 206. The controller 115 further includes an operation unit interface 211, a printing interface 210, a reading interface 212, a finisher interface 213, a sheet feeding unit interface 214, an external storage interface 207, and a LAN controller 205. The controller 115 includes the external storage device 208, and the external storage device 208 communicates with the CPU 201 via the external storage interface 207.

The CPU 201 performs overall control of access to and from various devices connected to a system bus 204 based on a control program stored in the ROM 203 or the external storage device 208.

The RAM 202 mainly functions as a main memory or a work area for the CPU 201. The interfaces 207, 211, 210, 212, 213, and 214 enable input and output of data between the devices connected to the controller 115 and the CPU 201.

The external storage device 208 is a storage unit that stores data. For example, a hard disk drive (HDD) or a solid-state drive (SSD) is used as the external storage device 208. The external storage device 208 is used to store an application program, font data, and form data. The external storage device 208 is used as a job storage area for temporarily spooling a print job and externally controlling the spooled job.

The external storage device 208 stores image data read from the scanner 112 and image data of a print job as stored printing data. The external storage device 208 stores various logs such as a job log and an image log.

The non-volatile memory 206 stores various pieces of setting information.

The LAN controller 205 (a LAN interface) communicates with the client computer 102 or an external system via the LAN 105 and transmits and receives a control command and print data to and from the client computer 102 or the external system.

### (Hardware Configuration of Client Computer)

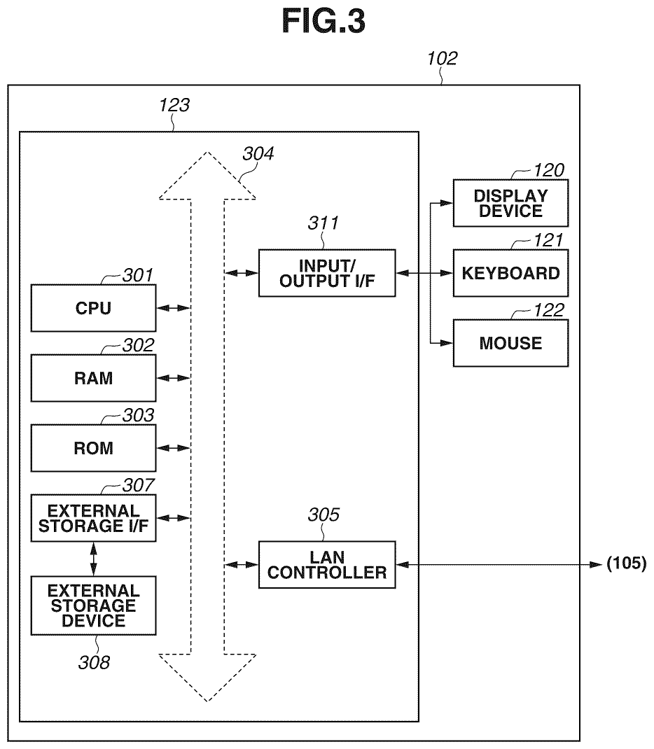

FIG. 3 is a block diagram illustrating a hardware configuration of the client computer 102.

As illustrated in FIGS. 1 and 3, the client computer 102 includes a display device 120, a keyboard 121, a mouse 122, and a controller 123.

The display device 120 is a display unit that displays information and is a liquid crystal monitor, for example. The display device 120 may be a device, having a function of receiving an input operation from the user, such as a touch panel method.

The keyboard 121 and the mouse 122 are input units that receive an input operation from the user.

The controller 123 is a control unit that performs overall control of the client computer 102.

The controller 123 includes a CPU 301, a RAM 302, a ROM 303, an input/output interface 311, an external storage interface 307, an external storage device 308, and a LAN controller 305.

The CPU 301 performs overall control of access to and from various devices connected to a system bus 304 based on a control program stored in the ROM 303 or the external storage device 308.

The RAM 302 mainly functions as a main memory or a work area for the CPU 301.

The external storage interface 307 and the input/output interface 311 enable the input and output of data between the devices connected to the controller 123 and the CPU 301. While, in the present exemplary embodiment, the input/output interface 311 is configured to connect to a plurality of devices, interfaces may be separately placed according to the number of devices connected to the controller 123.

The external storage device 308 is a storage unit that stores data. For example, an HDD or an SSD is used as the external storage device 308. The external storage device 308 is used to store an application program, font data, and form data.

The LAN controller 305 (a LAN interface) communicates with the image forming apparatus 101 or an external system via the LAN 105 and transmits and receives a control command and print data to and from the image forming apparatus 101 or the external system.

### Sheet Management Application

The sheet management application is application software with which the operator checks attributes of sheets set for the sheet feeding trays 114 of the image forming apparatus 101 and sets attribute information on the sheets to the sheet feeding trays 114. This application is executed by the controller 123 on the client computer 102. This application is executed by the CPU 301 loading a program stored in the external storage device 308 into the RAM 302 in the controller 123.

In the following descriptions and diagrams, the image forming apparatus 101 will be referred to as a printer.

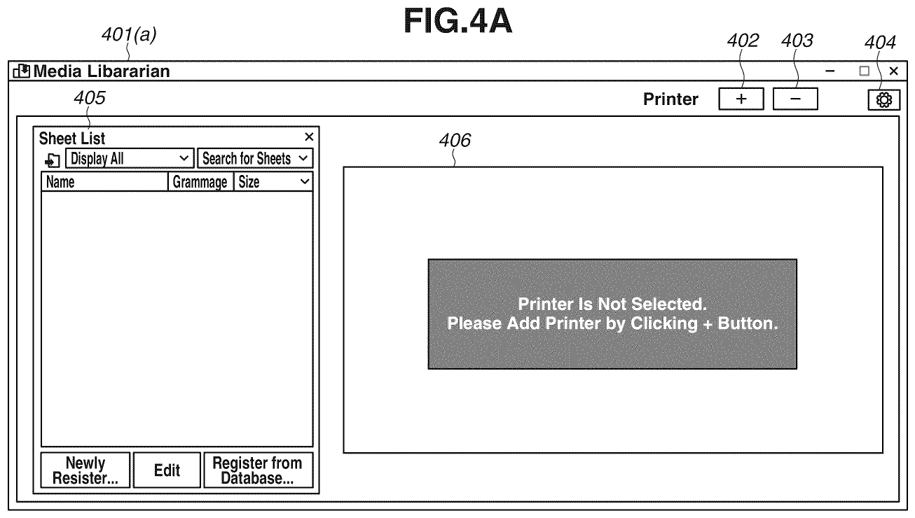

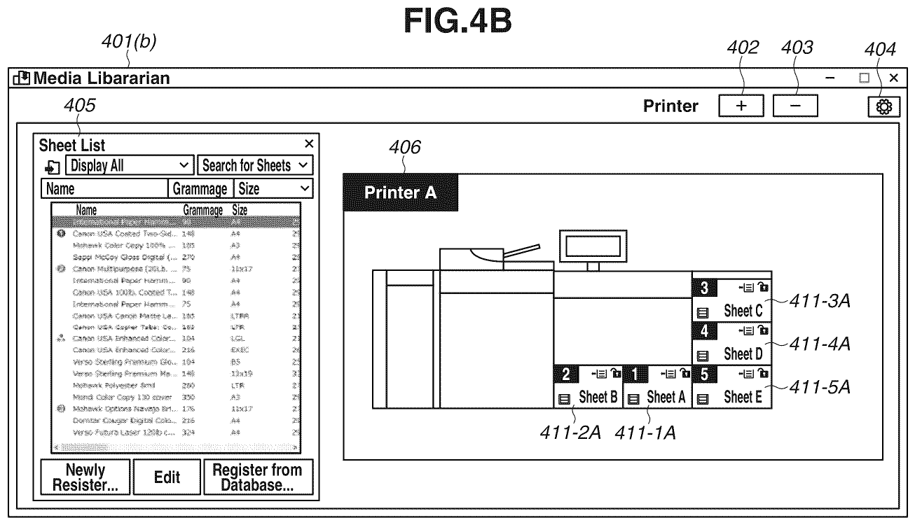

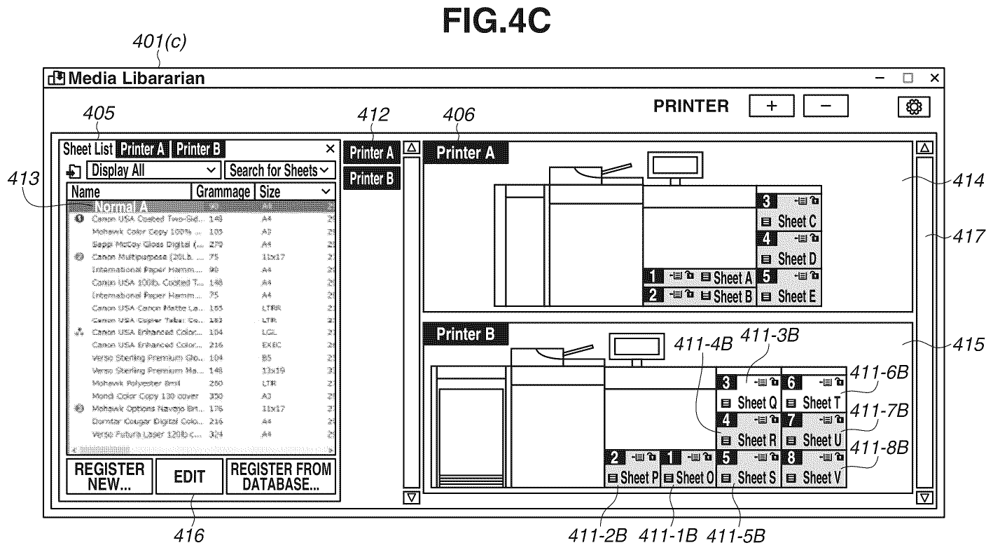

With reference to FIGS. 4A to 7C, a detailed description is given of processing from a start of the sheet management application according to the present exemplary embodiment to a connection of the sheet management application to the printer 101 as an operation target and examples of screens.

### (Top Screens)

FIGS. 4A to 4C are diagrams illustrating examples of top screens of the sheet management application according to the present exemplary embodiment. A top screen 401(a) is generated as drawing data in the RAM 302 according to an instruction from the CPU 301. The CPU 301 outputs the drawing data to the display device 120 and displays the drawing data on the display device 120.

A detailed description will be given in the description of flowcharts described below.

### (Login Screen)

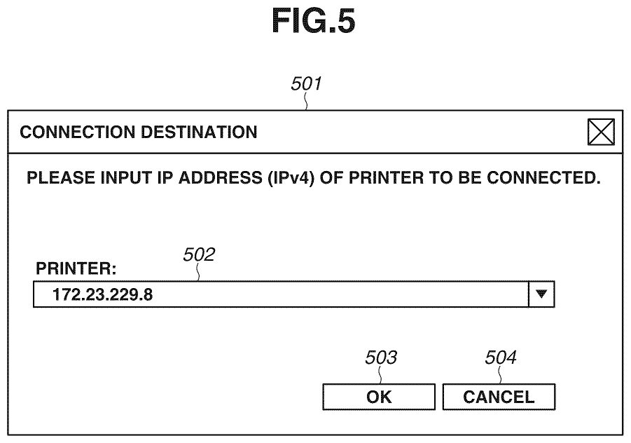

FIG. 5 is a diagram illustrating an example of a login screen on which a printer 101 to be used in the sheet management application according to the present exemplary embodiment is designated. A connection destination input screen 501 is generated as drawing data in the RAM 302 according to an instruction from the CPU 301. The CPU 301 outputs the drawing data to the display device 120 and displays the drawing data on the display device 120.

A detailed description will be given in the description of the flowcharts described below.

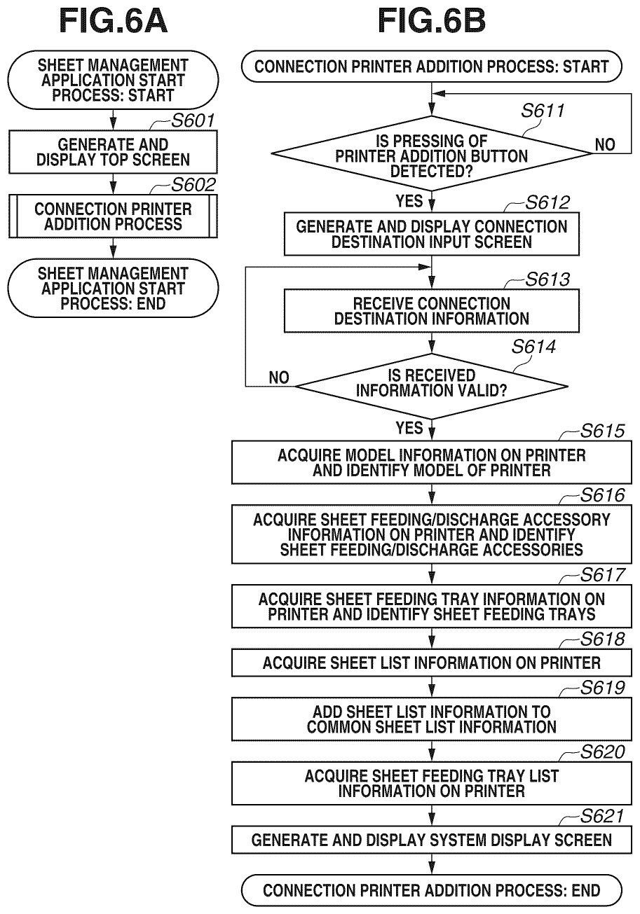

FIGS. 6A and 6B are flowcharts illustrating a procedure of a sheet management application start process according to the present exemplary embodiment and a procedure of designating a printer 101 and connecting to the printer 101. The procedures illustrated in these flowcharts are executed by the CPU 301 loading a program stored in the external storage device 308 into the RAM 302 in the controller 123.

### (Sheet Management Application Start Process)

With reference to FIG. 6A, the procedure of the sheet management application start process is described. This procedure is started in response to detection of the user executing the start of the sheet management application on the client computer 102. Detection of execution of the start of the sheet management application is receipt of an instruction to start the sheet management application by any means, for example, user's pressing performed on an application icon (not illustrated) displayed on the display device 120 via an input device.

When the start process is started, in step S601, the controller 123 generates a top screen 401(a) illustrated in FIG. 4A of the sheet management application and displays the top screen 401(a) on the display device 120.

The top screen 401(a) has a printer addition button 402 to add a printer 101 to be operated by the sheet management application, a printer deletion button 403 to delete a printer 101 operated by the sheet management application, and a system settings button 404 to perform a system setting of the sheet management application.

A sheet list display area 405 displays a sheet list. A printer information display area 406 displays printer information. Since no printer has been connected to the sheet management application immediately after the start of the sheet management application, information is not displayed in FIG. 4A.

After the top screen 401(a) is displayed, the processing proceeds to a connection printer addition process in step S602.

### (Printer Addition Process)

FIG. 6B is a flowchart illustrating a detailed processing procedure of the connection printer addition process in step S602.

First, in step S611, the controller 123 detects pressing performed on the printer addition button 402. In a case where the controller 123 detects that pressing has been performed on the printer addition button 402 (YES in step S611), the processing proceeds to step S612. In a case where the controller 123 does not detect that pressing has been performed on the printer addition button 402 (NO in step S611), the controller 123 waits in this state until pressing performed on the printer addition button 402 is detected.

In step S612, the controller 123 generates the connection destination input screen 501 illustrated in FIG. 5 to connect to a printer 101 to be operated by the sheet management application, and displays the connection destination input screen 501 on the display device 120.

As illustrated in FIG. 5, the connection destination input screen 501 includes an address entry field 502, an OK button 503, and a CANCEL button 504.

The address entry field 502 is a field to which an Internet Protocol (IP) address or a host name of the printer 101 as the connection destination is input. While, in FIG. 5, the address entry field 502 is a drop-down list, the present disclosure is not limited to this. The controller 123 receives an input operation from the user and displays information on the input operation in the address entry field 502.

The OK button 503 is a button for connecting the sheet management application to the printer 101 according to the setting in the address entry field 502.

The CANCEL button 504 is a button to end the connection destination input screen 501 without connecting to the printer 101.

In step S613, in response to input of an address in the address entry field 502 and pressing performed on the OK button 503 on the connection destination input screen 501, the controller 123 receives the information input to the address entry field 502.

Next, in step S614, the controller 123 determines whether the connection destination information input to the connection destination input screen 501 is valid.

The controller 123 attempts to connect to a connection destination designated by the input address.

In a case where the controller 123 determines that the connection destination is a valid printer 101 (YES in step S614), the controller 123 notifies the printer 101 of an IP address of the client computer 102 and causes the printer 101 to register the IP address, and the processing proceeds to step S615. In a case where no response is returned from the designated connection destination, the controller 123 determines that the connection destination information is invalid (NO in step S614), the processing returns to step S613. In step S613, the controller 123 waits for an input again. In this process, for example, the controller 123 may display the connection destination input screen 501 with a message that the input connection is invalid (not illustrated), to inform the user of the result.

After completion of the connection to the designated printer 101, then in step S615, the controller 123 identifies a model of the printer 101. The controller 123 communicates with the printer 101 and acquires model information. Then, based on model identification information held in advance in the sheet management application, the controller 123 identifies a model of the printer 101 and acquires basic configuration information. The acquired information is used in generation of a system display screen described below. After completion of the identifying of the model in step S615, the processing proceeds to step S616.

In step S616, the controller 123 identifies sheet feeding/discharge accessory information on sheet feeding/discharge accessories connected to the printer 101. The controller 123 communicates with the printer 101 and acquires information on the scanner 112 and the finisher 113 connected to the print engine 110. The acquired information is used in generation of the system display screen. After completion of the identifying of these options in step S616, the processing proceeds to step S617.

In step S617, the controller 123 identifies a sheet feeding tray list of the sheet feeding trays 114 connected to the printer 101 as a sheet management target. The controller 123 communicates with the printer 101 and acquires the number of the sheet feeding trays 114 connected to the printer 101 and setting information on the sheet feeding trays 114. Examples of the setting information on the sheet feeding trays 114 acquired in this process include information on names of the sheet feeding trays 114 and sizes and grammages that can be set to the respective sheet feeding trays 114. The acquired setting information on the sheet feeding trays 114 is used in generation of the system display screen or in determination of whether a sheet can be set to the sheet feeding trays 114. After completion of the identifying of the sheet feeding trays 114 in step S617, the processing proceeds to step S618.

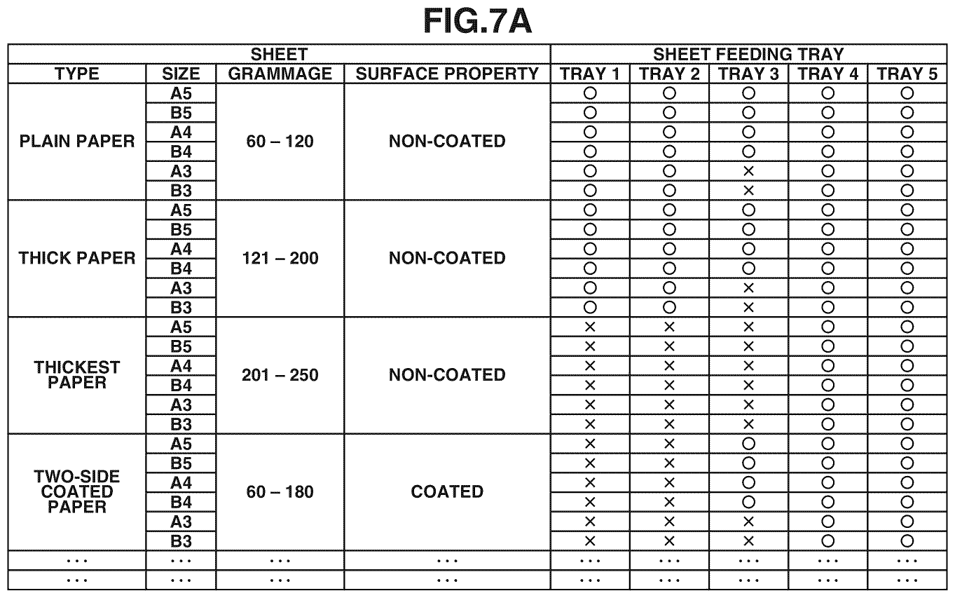

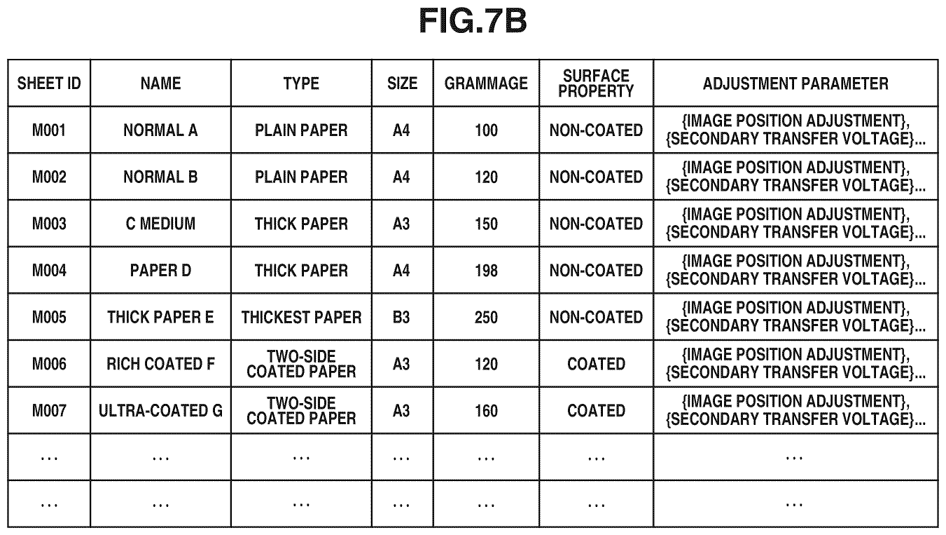

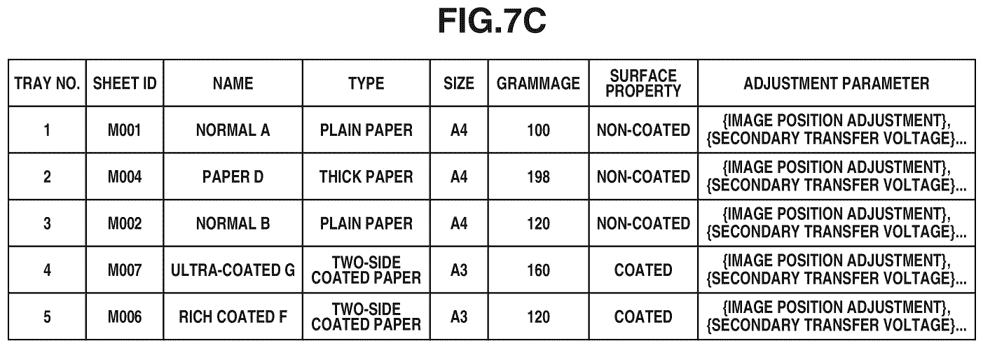

FIG. 7A is an example of the sheet feeding tray setting information according to the present exemplary embodiment. This information is stored in the external storage device 208 of the printer 101 and is loaded into the RAM 202 and used by the CPU 201. In response to a request from the controller 123, the controller 115 transmits the sheet feeding tray setting information on the sheet feeding trays 114 loaded into the RAM 202. The controller 123 acquires the information and uses the information to identify the sheet feeding trays 114.

The sheet feeding tray setting information describes specifications of a sheet that can be set in the sheet feeding trays 114. For example, a sheet having the sheet type of thick paper and having the sheet size of A3 can be set in a tray 1, but cannot be set in a tray 3.

In step S618, the controller 123 communicates with the printer 101 and acquires sheet list information on a list of sheets that can be set to the printer 101. The sheet list information is stored in the external storage device 208 of the printer 101 and is loaded into the RAM 202 and used by the CPU 201. In response to a request from the controller 123, the controller 115 transmits the sheet list information loaded into the RAM 202, and the controller 123 acquires the information.

FIG. 7B is an example of the sheet list information on the printer 101. Examples of sheet information is a group of parameters including SHEET ID, NAME each of which includes attribute information to be used in printing. SHEET ID is uniquely assigned to NAME of a commercial sheet, and SHEET ID and NAME are registered as sheet information in the sheet list information.

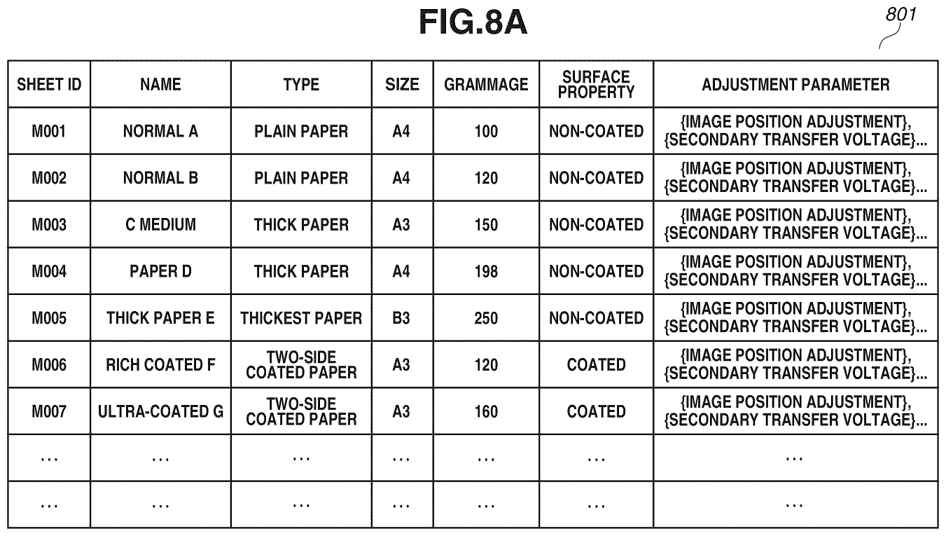

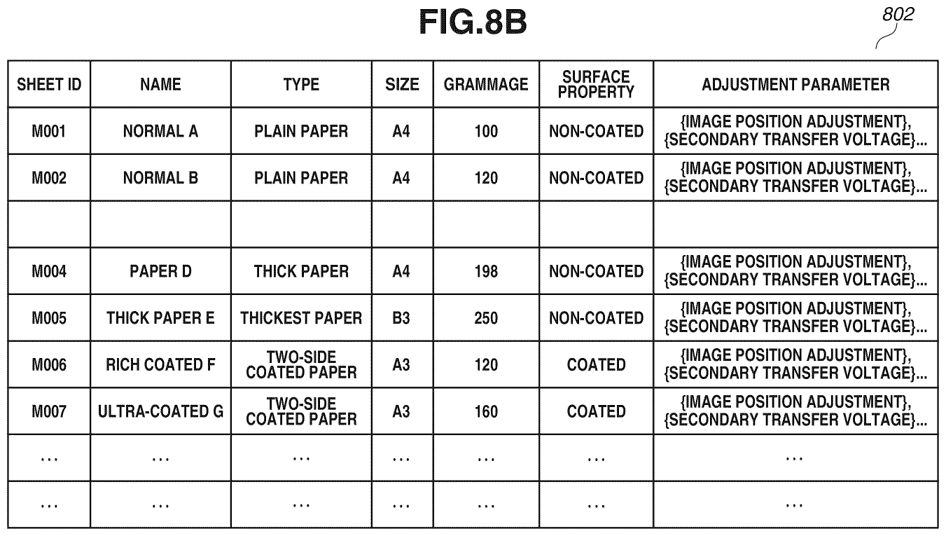

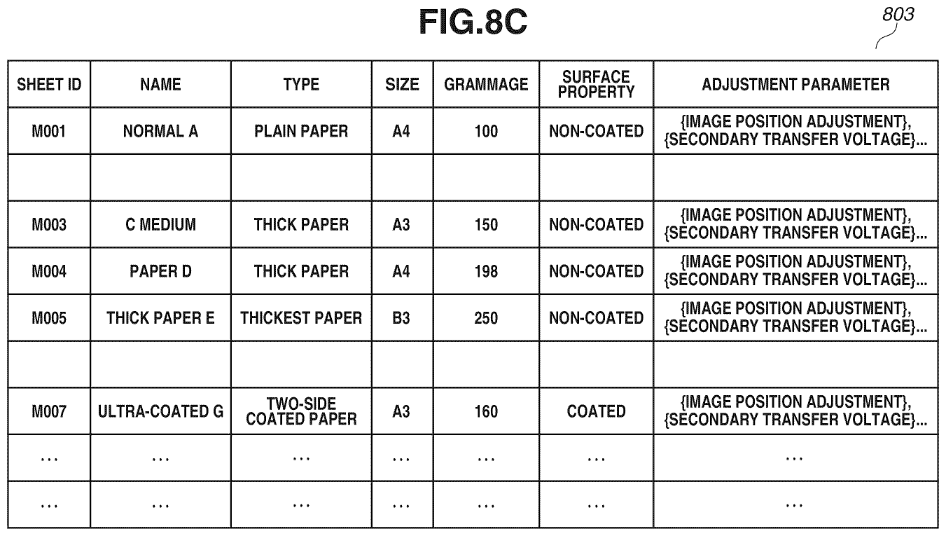

In step S619, in the present exemplary embodiment, the controller 123 adds the acquired information to a table 801 of common sheet list information illustrated in FIG. 8A. The process in this procedure will be described below in a description of a flowchart in which common sheet list information is generated from sheet list information. This information is used in generation of the system display screen. After completion of the generation of the common sheet list information, the processing proceeds to step S620.

In step S620, the controller 123 acquires sheet information currently set in the sheet feeding tray list of the printer 101. The controller 123 communicates with the printer 101 and acquires sheet information set to the respective sheet feeding trays 114 identified in step S617. In the present exemplary embodiment, the sheet information set to the respective sheet feeding trays 114 of the printer 101 is referred to as sheet feeding tray list information. The acquired information is used in generation of the system display screen. After completion of the acquisition of the sheet feeding tray list information, the processing proceeds to step S621.

FIG. 7C is an example of the sheet feeding tray list information according to the present exemplary embodiment. This information is stored in the external storage device 208 of the printer 101 and is loaded into the RAM 202 and used by the CPU 201. In response to a request from the controller 123, the controller 115 transmits sheet information set in the sheet feeding tray list loaded into the RAM 202. The controller 123 acquires the information.

This information describes the sheet information currently set for the sheet feeding trays 114.

In step S621, based on the information acquired in steps S615 to S620, the controller 123 generates a top screen 401(b) of the sheet management application illustrated in FIG. 4B and displays the top screen 401(b) on the display device 120.

The top screen 401(b) is an example of a screen after completion of the connection to a first printer, the printer 101A. The top screen 401(b) is different from the top screen 401(a) in the following respects.

In the sheet list display area 405, the controller 123 displays the sheet list information on the printer 101A acquired in step S618.

Further, in the printer information display area 406, the controller 123 draws, based on the information on the printer 101A acquired in steps S615 to S618 and S620, a shape of the printer and information on the sheet feeding tray list. As for the shape of the printer, a plurality of image patterns according to printer models, options, and information on sheet feeding tray lists may be held in advance in the external storage device 308, and an image may be selected and drawn according to the information on the printer 101A acquired by the controller 123. Alternatively, the image is held in the external storage device 208 of the printer 101, and in an inquiry to the printer 101 to identify the model and the sheet feeding/discharge accessory information in step S615 and the subsequent steps, the image is received from the printer 101.

Since the printer 101A includes the five sheet feeding trays 114-1A to 114-5A, the controller 123 generates and draws images of sheet feeding trays 411-1A to 411-5A based on the information on the sheet feeding tray list acquired in steps S617 and S620. By viewing this screen, the user can easily check which sheet is currently set in which sheet feeding tray 114.

After completion of the generation and the display of the system display screen in step S621, the detailed procedure of the processing in FIG. 6B, i.e., the connection printer addition process in step S602 in FIG. 6A, ends.

The description returns to the flowchart illustrated in FIG. 6A. The procedure of the sheet management application start process ends, and after the start of the sheet management application, the controller 123 waits in a state in which the controller 123 is ready to receive an input operation from the user via an application screen.

### <Sheet List Information>

FIGS. 8A to 8C illustrate examples of sheet list information held in the sheet management application and the printers 101A and 101B. The table 801 in FIG. 8A is a sheet list (hereinafter referred to as “common sheet list information”) which is managed in the external storage device 308 of the controller 123 and in which sheet information to be used in the sheet management application is held together.

A table 802 in FIG. 8B and a table 803 in FIG. 8C are pieces of sheet list information that are managed in the external storage device 208 of the printer 101A and the external storage device 208 of the printer 101B, respectively. That is, FIG. 8A is an example of the common sheet list information held in the sheet management application according to the present exemplary embodiment. FIG. 8B is an example of the sheet list information on the printer 101A. FIG. 8C is an example of the sheet list information on the printer 101B.

A detailed description will be given in the description of the following flowcharts.

### <Management Tables>

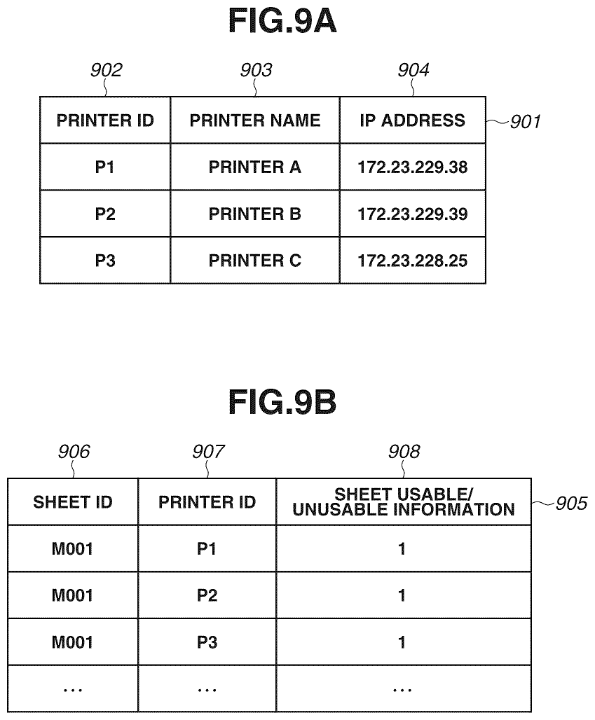

FIGS. 9A and 9B are examples of management tables that associate a sheet with a printer. The controller 123 manages two tables.

FIG. 9A illustrates a table 901 in which information on a printer 101 registered in the sheet management application is registered. The table 901 includes a printer identifier (ID) 902, a printer name 903, and an IP address 904.

FIG. 9B illustrates a table 905 that associates sheet information with a printer. The table 905 includes a sheet ID 906, a printer ID 907, and a sheet usable/unusable flag 908.

A detailed description will be given in the description of the following flowcharts.

### Processing Procedure of Generating Common Sheet List Information and Association Table

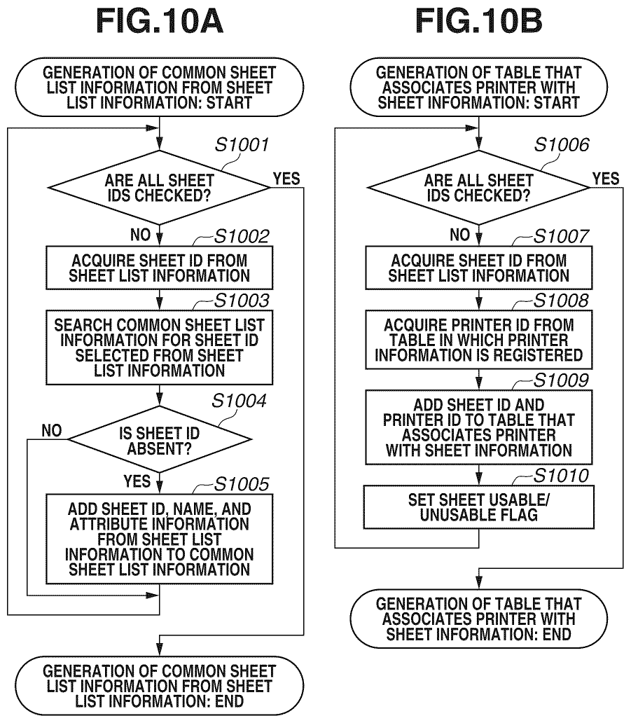

FIG. 10A illustrates a processing procedure of generating the common sheet list information from the sheet list information. FIG. 10B illustrates a processing procedure of generating a table that associates a printer with a sheet. The procedures illustrated in these flowcharts are executed by the CPU 301 loading a program stored in the external storage device 308 into the RAM 302 in the controller 123. These procedures are started in response to execution of the process in step S619 in FIG. 6B in association with the addition of the printer 101 on the client computer 102.

(Process of Generating Common Sheet List Information from Sheet List Information)

FIG. 10A illustrates the processing procedure of generating the common sheet list information from the sheet list information.

In step S1001, the controller 123 determines whether all the sheet IDs included in the sheet list information have been checked. In a case where the controller 123 determines that all the sheet IDs included in the sheet list information have been checked (YES in step S1001), the controller 123 ends this processing procedure for generation of the common sheet list information for the sheet management application from the sheet list information on the printer 101A. In a case where the controller 123 determines that not all the sheet IDs included in the sheet list information have been checked (NO in step S1001), the processing proceeds to step S1002.

In step S1002, the controller 123 acquires, from the sheet list information (FIG. 8B), a single sheet ID that has not been checked. The sheet ID may be the smallest ID among the sheet IDs that have not been acquired, or may be randomly acquired.

In step S1003, the controller 123 searches the common sheet list information for the acquired sheet ID.

In step S1004, the controller 123 determines whether the acquired sheet ID is absent in the searching. In a case where the controller 123 determines that the sheet ID is absent in the common sheet list information (YES in step S1004), the processing proceeds to step S1005. In a case where the controller 123 determines that the sheet ID is not absent in the common sheet list information, i.e., information on the sheet ID is present (NO in step S1004), the controller 123 skips the processing of the common sheet list information, and the processing returns to step S1001.

In step S1005, the controller 123 adds the sheet ID, the name, and the attribute information from the sheet list information on the printer 101 to the common sheet list information, and the processing returns to step S1001.

FIG. 8A illustrates the state of the common sheet list information after the connection printer addition process performed on the printers 101A and 101B. As a result of the determination in step S1004, the common sheet list information contains “M003”, which is a sheet ID that is not in the sheet list information on the printer 101A. The common sheet list information also contains “M002” and “M006”, which are sheet IDs not included in the sheet list information on the printer 101B.

(Process of Generating Table that Associates Printer with Sheet)

FIG. 10B illustrates the processing procedure of the generation of the table that associates a printer with a sheet.

In step S1006, the controller 123 determines whether all the sheet IDs in the sheet list information has been checked. In a case where the controller 123 determines that all the sheet IDs in the sheet list information have been checked (YES in step S1006), the controller 123 ends this processing procedure in which the table 905 that associates a printer with a sheet is generated from the sheet list information on the printer 101A. In a case where the controller 123 determines that not all the sheet IDs in the sheet list information have been checked (NO in step S1006), the processing proceeds to step S1007.

In step S1007, the controller 123 acquires, from the sheet list information, a single sheet ID that has not been checked. The sheet ID may be the smallest ID among the sheet IDs that have not been acquired, or may be randomly acquired.

Next, in step S1008, the controller 123 acquires the printer ID 902 from the table 901 in which the printer information is registered.

In step S1009, the controller 123 adds the sheet ID and the printer ID to the table 905 that associates a printer with sheet information.

In step S1010, the controller 123 sets the sheet usable/unusable flag 908 in the table 905 that associates a printer with sheet information. The controller 123 sets the sheet usable/unusable flag 908 to “1”. The value “1” of the sheet usable/unusable flag 908 indicates that the sheet information can be assigned to the sheet feeding trays 114. The value “0” of the sheet usable/unusable flag 908 indicates that the controller 123 does not permit the assignment of the currently selected sheet information to the sheet feeding trays 114.

In the present exemplary embodiment, a printer that performs printing on a cut sheet using an electrophotographic technique has been illustrated as an example. The present disclosure is not limited to the use of the cut sheet printer using the electrophotographic technique. The present exemplary embodiment can also be implemented by the sheet management application acquiring sheet list information and sheet feeding tray information supported by printer, such as a cut sheet printer using an inkjet technique, a large-format printer, or a continuous form paper printer using a roll of paper. In the present exemplary embodiment, based on whether a sheet ID is present in the sheet list information held in the printer 101, the sheet usable/unusable flag 908 is assigned as an initial value when the printer 101 is added. The present disclosure, however, is not limited to this form. The sheet usable/unusable flag 908 may be set to “1” by giving priority to a sheet recommended by each printer. For example, in the case of the cut sheet printer using the inkjet technique, the sheet usable/unusable flag 908 may be set to “1” for photographic image paper (glossy paper) as an initial value when the printer is added, and the sheet usable/unusable flag 908 may be set to “0” for other sheets supported by the printer.

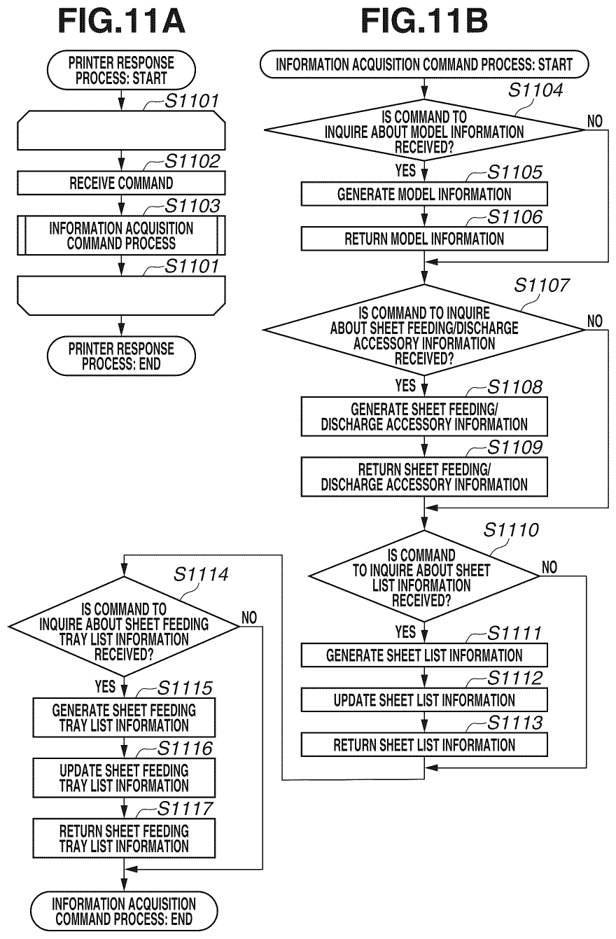

With reference to FIG. 11A, a description is given of a response process that is involved in the sheet management application start process and is performed by the printer 101 corresponding to the above processing procedures of the client computer 102. The process illustrated in this flowchart is executed by the CPU 201 loading a program stored in the external storage device 208 into the RAM 202 in the controller 115.

### (Process of Transmitting and Receiving Information on Printer and Information Acquisition Command Process)

FIG. 11A is a flowchart illustrating a procedure of the response process that is performed by the printer 101 according to the present exemplary embodiment. FIG. 11B is a flowchart illustrating a procedure of an information acquisition command process that is executed in association with the connection printer addition process.

FIG. 11A illustrates the operation of a module for the printer 101 to transmit and receive the information on the printer 101. FIG. 11B illustrates the processing procedure of a command in acquisition of the information on the printer 101 to be connected. As a command to transmit or receive the printer information, a command to inquire about the model information, a command to inquire about the sheet feeding/discharge accessory information, a command to inquire about the sheet list information, and a command to inquire about the sheet feeding tray list information may be separately received.

FIG. 11A illustrates the operation of the module for transmitting and receiving the information on the printer 101.

In step S1101, the controller 115 repeats the processes of steps S1102 and S1103.

In step S1102, the controller 115 receives a command to transmit and receive the information on the printer 101 that is transmitted from the client computer 102.

Next, in step S1103, the controller 115 performs an information acquisition command process (FIG. 11B) and transmits the information on the printer 101 to the client computer 102. This transmission/reception module is executed when the printer 101 is started, and repeats the procedure of the printer response process until the printer 101 is force quit.

### (Information Acquisition Command Process: Step S1103)

FIG. 11B is the procedure in processing of an information acquisition command to be used for a printer connection process.

In step S1104, the controller 115 determines whether a command to inquire about the model information has been received from the client computer 102. In a case where the controller 115 determines that a command to inquire about the model information has been received (YES in step S1104), the processing proceeds to step S1105. In a case where the controller 115 determines that a command to inquire about the model information has not been received (NO in step S1104), the processing proceeds to step S1107.

In step S1105, the controller 115 acquires the model information on the printer 101 from the external storage device 208, generates the model information in a data format that can be transferred to another apparatus, and stores the model information in the RAM 202.

Next, in step S1106, the controller 115 returns the model information generated in step S1105 to the client computer 102, and the processing proceeds to step S1107.

In step S1107, the controller 115 determines whether a command to inquire about the sheet feeding/discharge accessory information has been received from the client computer 102. In a case where the controller 115 determines that a command to inquire about the sheet feeding/discharge accessory information has been received (YES in step S1107), the processing proceeds to step S1108. In a case where the controller 115 determines that a command to inquire about the sheet feeding/discharge accessory information has not been received (NO in step S1107), the processing proceeds to step S1110.

In step S1108, the controller 115 acquires the sheet feeding/discharge accessory information on the sheet feeding/discharge accessories connected to the printer 101 from the print engine 110, the operation unit 111, the scanner 112, the finisher 113, and the sheet feeding trays 114 via the interfaces 210 to 214, respectively. Then, the controller 115 generates the sheet feeding/discharge accessory information in a data format that can be transferred to another apparatus and stores the sheet feeding/discharge accessory information in the RAM 202.

In step S1109, the controller 115 returns the sheet feeding/discharge accessory information generated in step S1108 to the client computer 102, and the processing proceeds to step S1110.

In step S1110, the controller 115 determines whether a command to inquire about the sheet list information has been received from the client computer 102. In a case where the controller 115 determines that a command to inquire about the sheet list information has been received (YES in step S1110), the processing proceeds to step S1111. In a case where the controller 115 determines that a command to inquire about the sheet list information has not been received (NO in step S1110), the processing proceeds to step S1114.

In step S1111, the controller 115 acquires the sheet list information on the printer 101 from the external storage device 208, generates the sheet list information in a data format that can be transferred to another apparatus, and stores the sheet list information in the RAM 202.

In step S1112, in a case where the user changes the sheet list information via the operation unit 111, the controller 115 updates the sheet list information.

In step S1113, the controller 115 returns the sheet list information updated in step S1112 to the client computer 102, and the processing proceeds to step S1114.

In step S1114, the controller 115 determines whether a command to inquire about the sheet feeding tray list information has been received from the client computer 102. In a case where the controller 115 determines that a command to inquire about the sheet feeding tray list information has been received (YES in step S1114), the processing proceeds to step S1115. In a case where the controller 115 determines that a command to inquire about the sheet feeding tray list information has not been received (NO in step S1114), the processing of this flowchart immediately ends.

In step S1115, the controller 115 acquires the sheet feeding tray list information on the printer 101 from the external storage device 208, generates the sheet feeding tray list information in a data format that can be transferred to another apparatus, and stores the sheet feeding tray list information in the RAM 202.

In step S1116, in a case where the user changes the sheet feeding tray list information via the operation unit 111, the controller 115 updates the sheet feeding tray list information.

In step S1117, the controller 115 returns the sheet feeding tray list information updated in step S1116 to the client computer 102, and the processing of this flowchart ends.

The description has been given of the start of the sheet management application and the connection to the first printer in the processes that are performed by both the client computer 102 and the printer 101.

A description will be given of a connection to a second printer, the printer 101B.

As one of the features of the print management system 100 according to the present exemplary embodiment, the sheet management application is configured to be able to simultaneously connect to a plurality of printers.

In the state where the first printer 101A is connected to the sheet management application and the top screen (system screen) 401(b) is displayed, in response to the printer addition button 402 being pressed, the controller 123 executes the processing procedure of the connection printer addition process described with reference to FIG. 6B.

The processing procedure is common to the above-described processing procedure, and the redundant description is omitted. In step S621, however, based on the information acquired in steps S615 to S620, the controller 123 generates a top screen 401(c) illustrated in FIG. 4C of the sheet management application and displays the top screen 401(c) on the display device 120.

The top screen 401(c) is an example of a screen displayed after completion of the connection to the second printer 101B.

The top screen 401(c) is different from the top screen 401(b) in the following respects.

In the sheet list display area 405, the controller 123 displays the common sheet list information in a sheet list area based on the sheet list information on the printers 101A and 101B acquired in step S618. The top screen 401(c) is configured with tabs that switch display of the pieces of sheet list information acquired from the printers 101A and 101B. For example, FIG. 4C illustrates a state where the common sheet list information is displayed in the sheet list display area 405. In response to the controller 123 detecting that a tab button for the printer 101A is pressed on the top screen 401(c), the controller 123 switches the common sheet list information to the sheet list information acquired from the printer 101A and display the sheet list information in the sheet list display area 405. Each of the pieces of sheet list information displayed in the sheet list display area 405 does not necessarily need to have this configuration. For example, only the common sheet list information may be displayed, and the individual sheet lists may not be displayed. Further, in the printer information display area 406, the controller 123 draws two printers, the printers 101A and 101B, and information on the sheet feeding tray lists. The procedure of the drawing is similar to that in the method described with reference to the top screen 401(b), and the redundant description will be omitted. The controller 123 displays the two printers in parallel on the same screen, whereby the user can simultaneously check the sheet feeding trays 411-1A to 411-5A of the printer 101A and sheet feeding trays 411-1B to 411-8B of the printer 101B.

While a method for connecting to two printers and displaying the two printers on the same screen has been described, the number of printers to be connected to the sheet management application is not limited to two. A configuration in which three or more printers re connected to the sheet management application may be employed. The controller 123 may display all the plurality of printers connected to the sheet management application in the printer information display area 406, or may switch the display using a scroll bar 417. For example, the controller 123 may switch pieces of printer information displayed on the top screen 401(c) using a printer list function. The controller 123 displays printer names in a printer list area 412, and in response to the user selecting any of the printer names, the controller 123 displays the printer information in the printer information display area 406.

<Process of Associating Sheet Information with Printer>

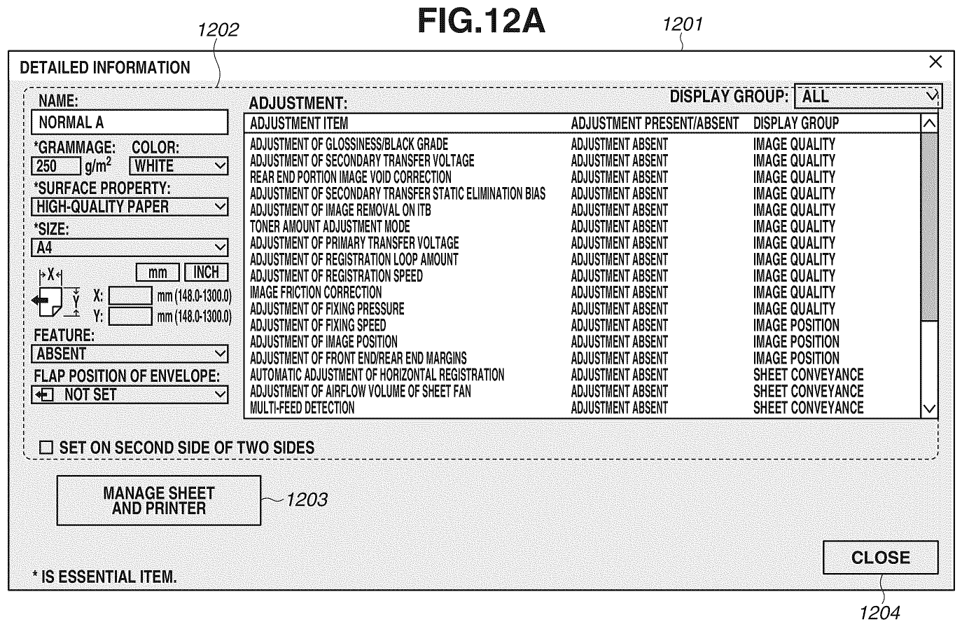

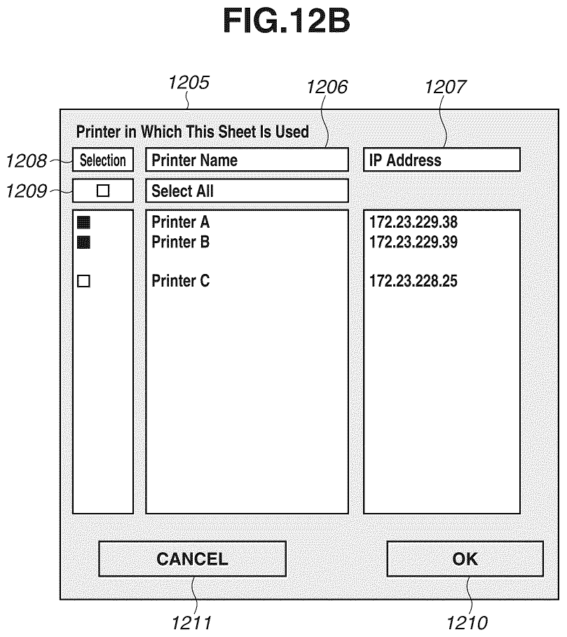

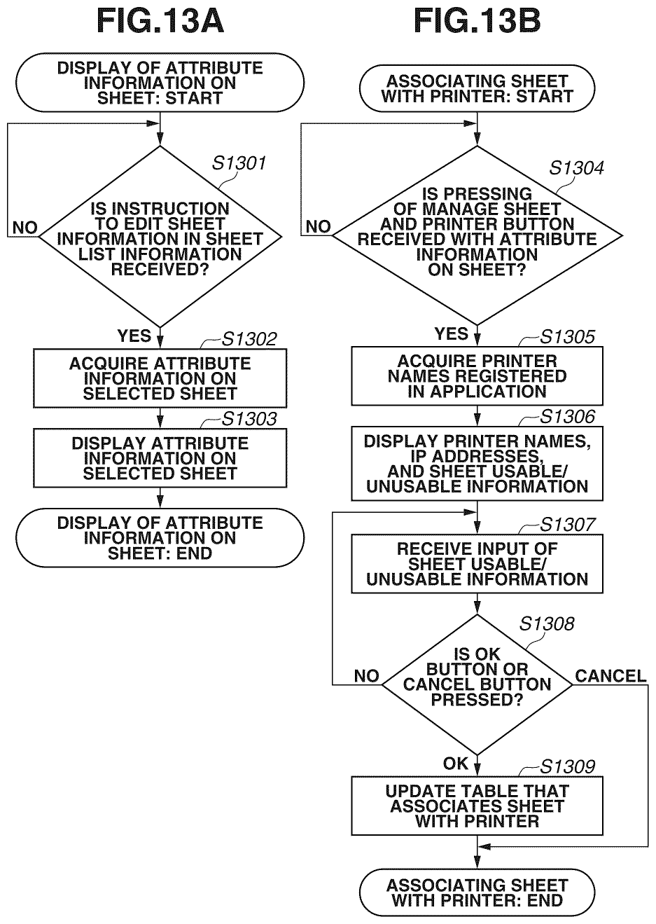

Next, with reference to FIGS. 12A and 12B and FIGS. 13A and 13B, a description is given of the process of associating a printer with sheet information, which is a feature of the sheet management application in the print management system 100 according to the present exemplary embodiment. As a feature of the sheet management application, the attribute information (name, grammage, and adjustment parameters) with respect to each sheet held in the printer 101 can be set on the client computer 102. For example, not only the name of the sheet set, but also the drawing start position of an image to be printed on the sheet can be adjusted (image position adjustment), and the value of adjusting a voltage when toner attached to a drum is transferred to paper (a secondary transfer voltage) can be changed. The sheet management application prepares a user interface for this purpose with respect to each piece of sheet information.

FIGS. 12A and 12B are examples of sheet attribute information screens. FIG. 12A illustrates a screen prepared by the controller 123 with respect to each piece of sheet information and on which the attribute information on the sheet is edited and adjusted. Via this screen, the controller 123 receives values of the attribute information specific to the sheet, such as the grammage, the surface property, and the size of the sheet, which have been edited by the user. Via this screen, the controller 123 also receives an instruction to start the image position adjustment or the adjustment of the secondary transfer voltage from the user. A sheet attribute information screen 1201 includes an attribute information display area 1202 where the attributes, such as the name and the grammage, can be edited, a MANAGE SHEET AND PRINTER button 1203, and a CLOSE button 1204. The association between a sheet and a printer, which is a feature of the present exemplary embodiment, is set on a screen 1205 illustrated in FIG. 12B which is displayed in response to pressing performed on the MANAGE SHEET AND PRINTER button 1203.

FIG. 12B is an example of a screen on which sheet information is associated with a printer.

The screen 1205 on which a sheet and a printer are associated with each other has three areas. A column 1207 displays an IP address of a printer 101 registered in the sheet management application by the user. A column 1206 displays a printer name corresponding to the IP address. A column 1208 includes a printer selection checkbox for determination of whether to associate the printer 101 with the sheet.

A detailed description will be given in the description of the following flowcharts.

### (Process of Displaying Screen)

FIG. 13A is a flowchart illustrating a processing procedure of displaying the sheet attribute information screen 1201 of the sheet management application according to the present exemplary embodiment. FIG. 13B is a flowchart illustrating a processing procedure of displaying the screen 1205 on which a sheet and a printer are associated with each other. The processes illustrated in these flowcharts are executed by the CPU 301 loading a program stored in the external storage device 308 into the RAM 302 in the controller 123.

In step S1301, the controller 123 receives an instruction to edit sheet information according to an operation of the user. Specifically, the operation is performed by the user selecting sheet information in the sheet list display area 405 on the top screen 401(c) in FIG. 4C and pressing an EDIT button 416 or by the user selecting sheet information 413 in the sheet list and double-clicking the sheet information 413 with the mouse 122. In a case where the controller 123 has received an instruction to edit sheet information (YES in step S1301), the processing proceeds to step S1302. In a case where the controller 123 has not received an instruction to edit sheet information (NO in step S1301), the controller 123 waits for an input.

In step S1302, the controller 123 acquires all the attribute information on the sheet in the sheet information selected by the user from the common sheet list information.

Next, in step S1303, the controller 123 displays the attribute information on the selected sheet in the attribute information display area 1202, and this display process ends.

In a case where the CLOSE button 1204 is pressed, the controller 123 saves the values in the attribute information display area 1202 in the sheet list information and ends the sheet attribute information screen 1201.

(Process of Associating Sheet with Printer)

FIG. 13B is a flowchart illustrating the processing procedure of associating a sheet with a printer.

In step S1304, the controller 123 receives information on whether the MANAGE SHEET AND PRINTER button 1203 displayed on the sheet attribute information screen 1201 in FIG. 12A has been pressed by the user. In a case where the controller 123 determines that the MANAGE SHEET AND PRINTER button 1203 has been pressed (YES in step S1304), the processing proceeds to step S1305. In a case where the controller 123 determines that the MANAGE SHEET AND PRINTER button 1203 has not been pressed (NO in step S1304), the controller 123 waits for an input from the user.

In step S1305, the controller 123 acquires printer names registered in the sheet management application in the connection printer addition process illustrated in FIG. 6B from the table 901 in which the printer information is registered. FIG. 12B is an example of the screen 1205 on which the user associates sheet information with a printer. The controller 123 displays printer names acquired from printers 101 when this screen is displayed.

In step S1306, the controller 123 displays the printer names, the IP addresses, and the sheet usable/unusable information acquired from the table 905 in which sheet information and a printer are associated with each other. The table 905 includes the sheet ID 906, the printer ID 907, and the sheet usable/unusable flag 908. The controller 123 displays the sheet usable/unusable flag 908 in the column 1208 of a printer selection area. In the present exemplary embodiment, with respect to a selected printer 101, the controller 123 displays a black rectangle in the column 1208 of the printer selection area. In the present exemplary embodiment, the controller 123 has a SELECT ALL checkbox 1209 that enables the user to collectively select all the printers 101, at the beginning of the column of the column 1206 where printer names are displayed. If the controller 123 cannot acquire a printer name, the controller 123 may use the table 901 in FIG. 9A and gray out the printer name using previously acquired information.

Next, in step S1307, the controller 123 receives selection of the column 1208 of the printer selection area from the user using the keyboard 121 and the mouse 122.

In step S1308, the controller 123 checks whether an OK button 1210 or a CANCEL button 1211 in FIG. 12B is pressed.

In a case where the controller 123 determines that neither of the two buttons is pressed (NO in step S1308), the processing returns to step S1307. In step S1307, the controller 123 waits for either of the two buttons to be pressed. In a case where the controller 123 determines in step S1308 that the OK button 1210 is pressed (OK in step S1308), the processing proceeds to step S1309. In a case where the controller 123 determines that the CANCEL button 1211 is pressed (CANCEL in step S1308), this processing ends.

In step S1309, the controller 123 updates the table 905 that associates a sheet with a printer in FIG. 9B, and this processing ends.

### (Process of Setting Sheet)

Next, with reference to FIGS. 8A to 8C to FIGS. 14A and 14B, a description is given of the process of setting a sheet for a sheet feeding tray 114 by the sheet management application in the print management system 100 according to the present exemplary embodiment.

One of the functions of the sheet management application is a setting of a sheet for a sheet feeding tray 114 by a user operation.

In the present exemplary embodiment, a description is given of the configuration of the top screen 401(c) illustrated in FIG. 4C where two printers are connected to the sheet management application. First, the controller 123 receives selection of sheet information in the common sheet list information displayed in the sheet list display area 405. As a result, printer information on a printer 101 to which the selected sheet is assignable is displayed in the printer list area 412 and the printer information display area 406 according to the sheet information. For example, specifically, in a case where sheet information (a sheet name “NORMAL A” and a sheet ID “M001”) held in common in the first printer (e.g., the printer 101A) and the second printer (e.g., the printer 101B) is selected in the sheet list information, Printer A as the printer 101A and Printer B as the printer 101B to which the selected sheet is assignable are displayed.

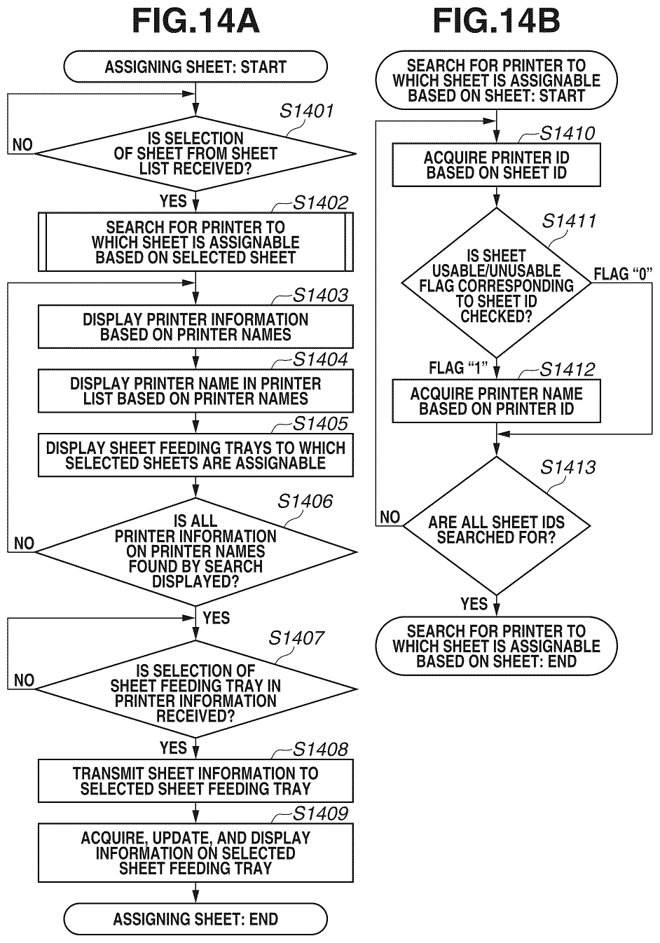

FIG. 14A is a flowchart illustrating the processing procedure of displaying a printer to which a sheet is assignable based on sheet information according to the present exemplary embodiment. FIG. 14B is a flowchart illustrating the processing procedure of searching for a printer to which a sheet is assignable based on the sheet.

The processes illustrated in these flowcharts are executed by the CPU 301 loading a program stored in the external storage device 308 into the RAM 302 in the controller 123.

(Process of Displaying Printer to which Sheet is Assignable)

This procedure is started in a standby state where a predetermined operation of the user is detected on the top screen 401(c) after completion of the application start process and the printer connection process on the two printers on the client computer 102.

In display of the top screen 401(c), in step S1401, the controller 123 detects that the sheet information 413 in the common sheet list information displayed in the sheet list display area 405 is selected by a user operation. As an example, a description will be given of a case in which the controller 123 detects the sheet ID “M001” and the sheet name “NORMAL A” as the sheet information 413 in the common sheet list information. The detection of the selection by the user operation is, for example, the state where the controller 123 detects that the area of the sheet information 413 displayed in the sheet list display area 405 drawn on the top screen 401(c) has been pressed by the user performing an operation using the mouse 122. Examples of the state detected by the controller 123 also include a state in which the controller 123 detects that an ENTER key of the keyboard 121 has been pressed with the area of the sheet information 413 being selected, in addition to a click operation using the mouse 122. In a case where the controller 123 determines that the selection of the sheet information 413 has been detected in step S1401 (YES in step S1401), the processing proceeds to step S1402. In a case where the controller 123 determines that the selection has not been received (NO in step S1401), the controller 123 waits until the sheet information 413 is selected by a user operation.

In step S1402, the controller 123 searches for a printer to which a sheet is assignable, based on the sheet information 413 selected in step S1401. In this search work, the controller 123 performs the search using the common sheet list information generated from the sheet list information acquired in step S618 in the connection printer addition process.

(Process of Searching for Printer to which Sheet is Assignable: Step S1402)

FIG. 14B illustrates a flowchart of the search processing. This flowchart is started in response to the controller 123 acquiring a sheet ID from the common sheet list information, and is performed until there is no more printer name that the controller 123 can acquire by executing the flowchart. The controller 123 saves an acquired printer name in the RAM 302 and uses the printer name to determine printer information to be displayed in the printer information display area 406 or a printer name to be displayed in the printer list area 412.

First, in step S1402, the controller 123 obtains the sheet ID detected from the common sheet list information. As an example, the controller 123 acquires “M001”, which is the sheet ID of “normal A”.

In step S1410, the controller 123 acquires a printer ID based on the sheet ID.

Next, in step S1411, the controller 123 checks the value of the sheet usable/unusable flag 908 corresponding to the sheet ID 906 in the table 905 illustrated in FIG. 9B. In a case where the controller 123 determines that the value of the sheet usable/unusable flag 908 is “1” (FLAG “1” in step S1411), the processing proceeds to step S1412. In a case where the controller 123 determines that the value of the sheet usable/unusable flag 908 is “0” (FLAG “O” in step S1411), the processing proceeds to step S1413.

In step S1412, the controller 123 acquires a printer name based on the printer ID.

As an example, using the table 905 that associates a sheet with a printer, the controller 123 searches for “M001” based on the sheet ID 906 and obtains “P1” as the printer ID 907. Next, in step S1411, the controller 115 checks whether the sheet usable/unusable flag 908 is “1”. With reference to the table 905, in a case where the sheet ID is “M001” and the printer ID is “P1”, the sheet usable/unusable flag 908 is “1”. Thus, in step S1412, the controller 123 acquires a printer name based on the printer ID. Using the table 901, the controller 123 searches for “P1” acquired as the printer ID 907 based on the printer ID 902 and obtains “printer A” as the printer name 903. The controller 123 saves, in the RAM 302, the printer name “printer A” found by the search.

In step S1413, the controller 123 determines whether the controller 123 have searched for all the sheet IDs as the sheet ID 906 in the table 905. In a case where the controller 123 determines that not all the sheet IDs have been searched for (NO in step S1413), the processing returns to step S1410. In step S1410, the controller 123 checks the next printer ID 907 using a sheet ID.

For example, in a case where the sheet ID “M001”, the printer ID “P1”, and “1” as the sheet usable/unusable flag 908 are acquired using the table 905, since the controller 123 does not search for all the sheet IDs in step S1413, the controller 123 searches for a next printer ID using the sheet ID “M001”. In step S1410, the controller 123 acquires a next printer ID “P2” by using the table 905.

In a case where the controller 123 determines that all the sheet IDs in the table 905 have been searched for (YES in step S1413), the processing of this flowchart ends.

The controller 123 saves the printer names obtained in this flowchart in the RAM 302, and the controller 123 uses the printer names in the processes of step S1403 and subsequent steps.

The description returns to the flowchart in FIG. 14A.

In step S1403, the controller 123 displays printer information in the printer information display area 406 based on the printer names saved in the RAM 302 in the search work. As an example, in a case where “NORMAL A” is selected as the sheet information, the sheet ID 906 of “NORMAL A” is determined as “M001” based on the common sheet list information in FIG. 8A. Since the controller 123 has acquired “Printer A” as a printer name in the RAM 302 as described above, the controller 123 displays printer information 414 on “Printer A”.

In step S1404, the controller 123 displays a printer name in the printer list area 412 based on the printer names. Since the controller 123 obtains “Printer A” as a printer name as described above, the controller 123 displays a character string Printer A.

In step S1405, the controller 123 draws information on the sheet feeding tray list of the printer 101A in the printer information display area 406. The procedure of the drawing is similar to that in the method described with reference to the top screen 401(b), and the redundant description will be omitted. Based on the attribute information in the sheet information selected with respect to each sheet feeding tray 114 based on restriction information on sheets that can be set for the sheet feeding trays 114 of the printer 101 obtained in FIG. 7A, the controller 123 displays trays to which sheets are assignable. In the present exemplary embodiment, as an example, the controller 123 changes colors of display of the sheet feeding trays 114.

In step S1406, the controller 123 checks whether all the printer information found by the search using the sheet ID “M001” is displayed. In a case where the controller 123 determines that all the printer information on the printer names saved in the RAM 302 is not displayed (NO in step S1406), the processing returns to step S1403. In step S1403, the controller 123 displays printer information based on a next printer name. In a case where the controller 123 determines that all the printer information is displayed (YES in step S1406), the processing proceeds to step S1407.

In step S1407, the controller 123 receives selection of a sheet feeding tray 114 in the printer information by a user operation. Detection of the selection by the user operation is, for example, the state where the controller 123 detects that the area of the sheet feeding tray 411-1B in the printer information display area 406 drawn on the top screen 401(c) is pressed by the user performing an operation using the mouse 122. Examples of the state detected by the controller 123 include the state in which the controller 123 detects that an ENTER key of the keyboard 121 has been pressed in the state where the sheet feeding tray 411-1B has been selected, in addition to a click operation using the mouse 122.

Further, the operation to be detected in step S1407 may be a series of continuous operations such as drag and drop. Specifically, in response to the user dragging the mouse 122 on the sheet information 413 in the common sheet list information, moving the mouse 122 to the sheet feeding tray 411-1B, and dropping the sheet information 413, the controller 123 detects a sheet feeding tray 114 as a processing target.

In a case where the controller 123 determines that selection of a sheet feeding tray 114 has been received (YES in step S1407), the processing proceeds to step S1408. In a case where the controller 123 determines that a sheet feeding tray 114 has not been selected (NO in step S1407), the controller 123 waits until a sheet feeding tray 114 is selected in step S1407.

In step S1408, the controller 123 transmits the sheet information to the sheet feeding tray 114 of the printer 101B.

Next, in step S1409, the controller 123 acquires sheet feeding tray information on the sheet feeding tray 411-1B selected in step S1407. In step S1409, the controller 123 updates the sheet feeding tray information in which the assignment of the sheet is set from sheet feeding tray list information acquired from the printer 101B, and displays the sheet feeding tray information.

After completion of the assignment of the sheet information, this processing procedure ends.

By the above processing, in response to the user merely selecting a sheet in sheet list information, the print management system 100 can display printer information on a printer to which the sheet is assignable based on the sheet information selected by the user, whereby assignment of the sheet can be achieved by a simple operation.

As described above, according to the present exemplary embodiment, it is possible to connect a sheet management application to printers supporting the sheet management application, and display the sheet information on the plurality of printers on a screen of the single sheet management application, which enables centralization of management of sheet information set for sheet feeding trays of the printers.

In some printer models, even if a grammage and a surface property of a commercial sheet are within ranges supported by the printer, the commercial sheet is not registered because the commercial sheet is not recommended for the printer. In production printing, an administrator determines sheets for use in a printer as an operation rule in accordance with features of the printer. Registering these sheets in a table that associates sheet information with a printer according to the present exemplary embodiment reduces users' burden of remembering sheet setting information on sheet feeding trays of a plurality of printers, whereby the users can easily perform an operation.

In the first exemplary embodiment, a description has been given of a method in which the user selects sheet information in sheet tray information displayed on the sheet management application, and a printer and a sheet feeding tray to which a sheet corresponding to the sheet information is assignable are displayed in the printer information display area 406 and the printer list area 412.

In the first exemplary embodiment, the sheet management application has a table that associates sheet information with a printer, and restrictions are not imposed on the user performing the setting of a sheet via an operation unit of a printer. A second exemplary embodiment is to further improve the operability, and a description is given of a method in which information on whether a sheet can be set is held not only in the sheet management application but also in a printer by sharing, which allows sheet information on a sheet that can be set for a sheet feeding tray to be used in the printer.

A description has been given of a configuration in which the print management system 100 according the first exemplary embodiment generates common sheet list information based on sheet list information held in printers and manages the common sheet list information. Further, a description has been given of a configuration in which the sheet management application generates a table that associates a printer with sheet information, and the sheet management application stores and manages sheet usable/unusable information.

In the present exemplary embodiment, as a different configuration of the print management system 100, sheet usable/unusable information in a table that associates a printer with sheet information is reflected on sheet list information on each printer, which allows an operation unit of the printer to be available in management of an assignable sheet.

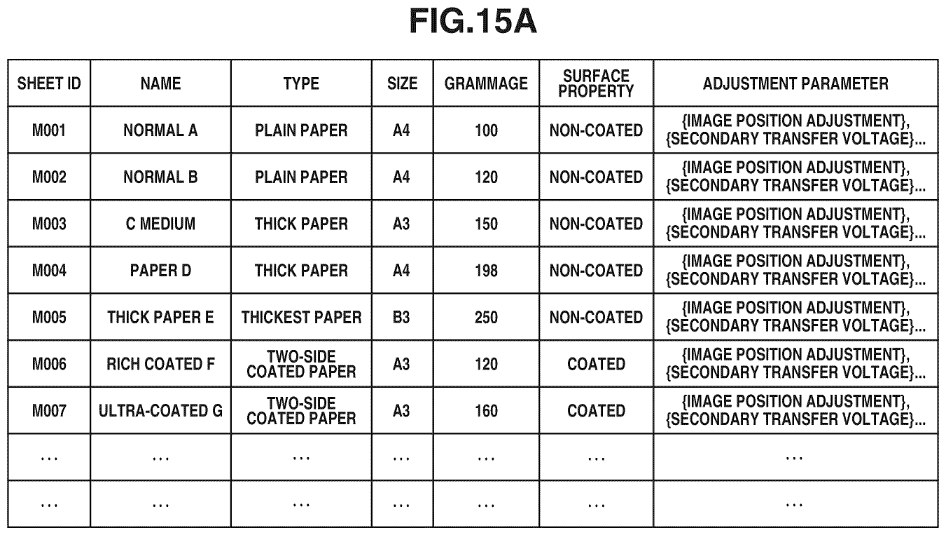

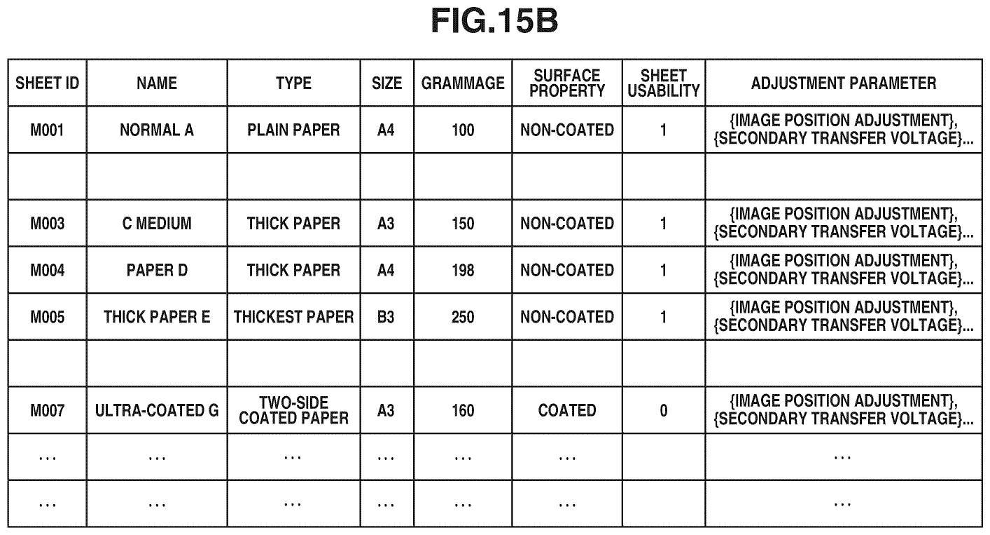

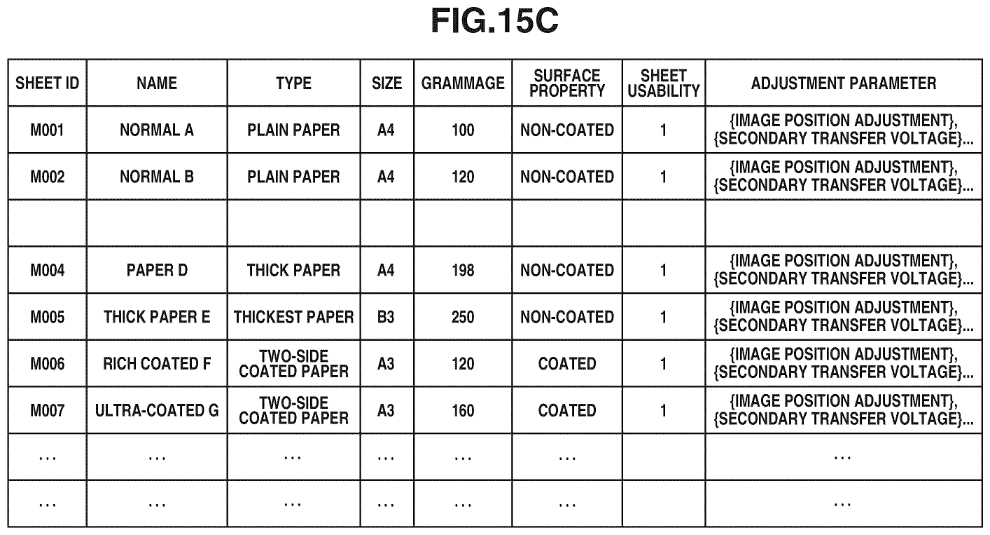

FIGS. 15A to 15C are diagrams illustrating sheet list information held in the sheet management application and the printers 101A and 101B according to the present exemplary embodiment. The sheet list information illustrated in FIGS. 15B and 15C are obtained by adding sheet usable/unusable information, sheet usable/unusable information to FIGS. 8B and 8C in the first exemplary embodiment. The same diagrams and the redundant descriptions as those in the first exemplary embodiment are omitted here.

The sheet usable/unusable information indicates whether, with respect to respective piece of sheet information on the printers 101A and 101B, the sheet management application permits or prohibits the use of the sheet in the printer.

In FIG. 15B, there is a sheet usable/unusable flag of a sheet ID “M007”. This value cooperates with the sheet usable/unusable setting in the sheet management application in a flowchart described below.

FIG. 15A illustrates common sheet list information generated by the sheet management application. FIG. 15B is an example of sheet list information on the printer 101A held in the controller 123. FIG. 15C is an example of sheet list information on the printer 101B held in the controller 123.

A detailed description will be given in the description of the following flowcharts.

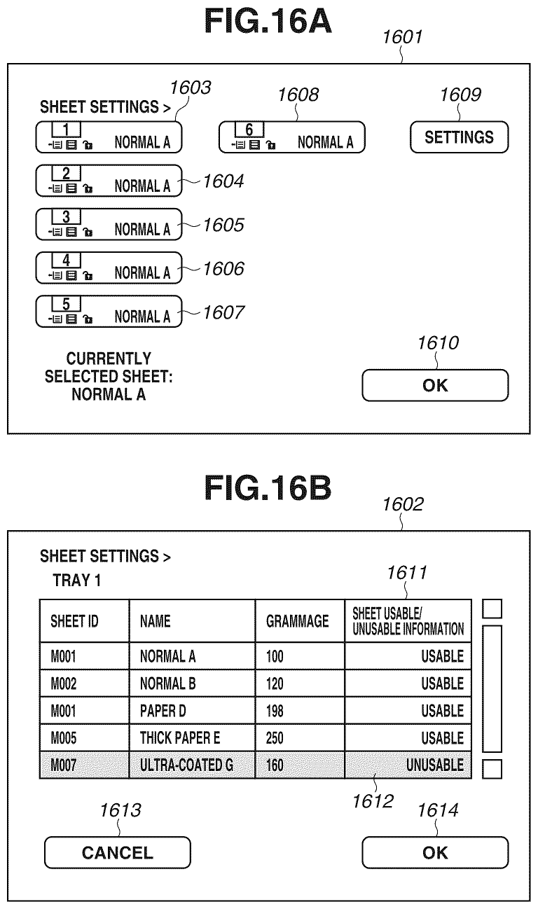

FIGS. 16A and 16B are examples of user interfaces of a setting of sheet types for the sheet feeding trays 114 displayed on the operation unit 111 of the printer 101A.

FIG. 16A illustrates a screen 1601 for the sheet feeding trays 114 in the sheet settings displayed on the operation unit 111.

Sheet feeding tray buttons 1603 to 1608 indicate the states of the respective sheet feeding trays 114 of the printer 101A. The controller 115 receives an input performed on any of the sheet feeding tray buttons 1603 to 1608 from the user and receives pressing performed on a SETTINGS button 1609, the controller 115 displays a setting screen 1602 for sheet types. An OK button 1610 closes the screen 1601 for the sheet feeding trays 114 in the sheet settings.

FIG. 16B illustrates the setting screen 1602 for sheet types in the sheet settings.

The controller 115 displays sheet types with which the printer 101A is compatible in an area 1611. In response to a CANCEL button 1613 being pressed, the controller 115 cancels and closes the setting screen 1602 for sheet types in the sheet settings. In response to an OK button 1614 being pressed, the controller 123 sets sheet information selected in the area 1611 by the user to the sheet feeding tray 114.

A detailed description will be given in the description of the following flowcharts.

### (Process of Updating Sheet List Information)

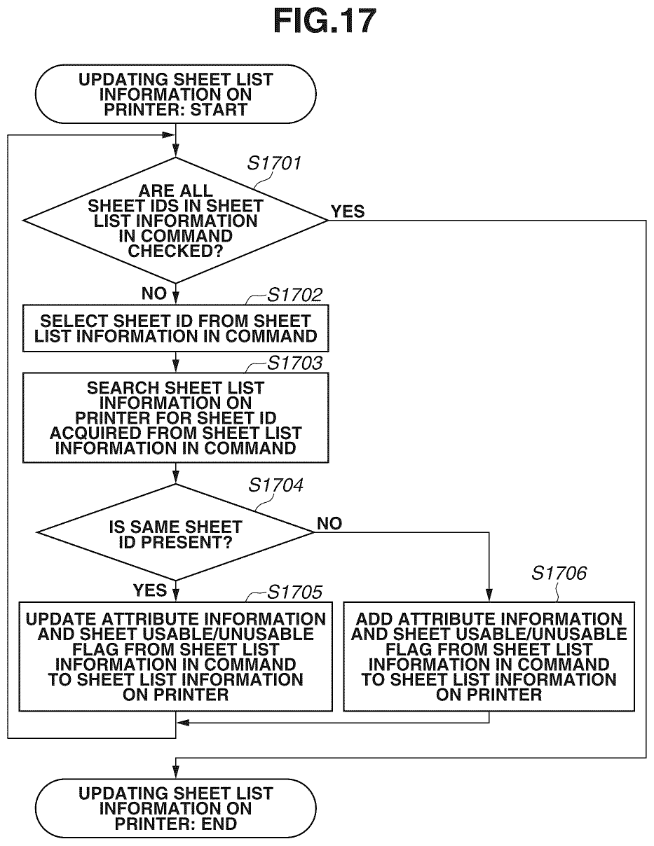

FIG. 17 is a flowchart in which the printer 101 updates the sheet list information according to the present exemplary embodiment. This processing procedure is executed in response to the process in step S1102 illustrated in FIG. 11 in which the controller 115 of the printer 101A receives a sheet list information setting command transmitted from the controller 123 when the controller 123 updates the table that associates sheet information with a printer in step S1309 in FIG. 13.

The process illustrated in this flowchart is executed by the CPU 201 loading a program stored in the external storage device 208 into the RAM 202 in the controller 115.

In step S1701, the controller 115 examines whether a sheet ID that has not been checked is present among all the sheet IDs in the sheet list information in the sheet list information setting command.

In a case where the controller 115 determines that all the sheet IDs included in the sheet list information in the sheet list information setting command have been checked (YES in step S1701), the controller 115 ends the procedure in which the sheet list information on the printer 101 is updated.

In a case where the controller 115 determines that not all the sheet IDs in the sheet list information attached to the command have not been checked in step S1701 (NO in step S1701), the processing proceeds to step S1702.

In step S1702, the controller 115 acquires a sheet ID from the sheet list information on the printer 101 sent from the controller 123. The sheet ID may be the smallest ID among the sheet IDs that have not yet been acquired, or may be randomly acquired.

In step S1703, the controller 115 searches the sheet list information held in the printer 101A for the sheet ID acquired from the sheet list information in the sheet list information setting command.

Next, in step S1704, the controller 115 checks whether the same sheet ID is present in the sheet list information on the printer 101A. In a case where the controller 115 determines that the same sheet ID as the sheet ID in the command is present (YES in step S1704), the processing proceeds to step S1705. In step S1705, the controller 115 updates the attribute information and the sheet usable/unusable flag based on the sheet list information in the command to the sheet list information on the printer 101A. In a case where the controller 115 determines that the same sheet ID as the sheet ID acquired from the command is not present (NO in step S1704), the processing proceeds to step S1706. In step S1706, the controller 115 adds the sheet ID, the attribute information, and the sheet usable/unusable flag in the command to the sheet list information on the printer 101A.

### (Process of Setting Sheet Feeding Tray)

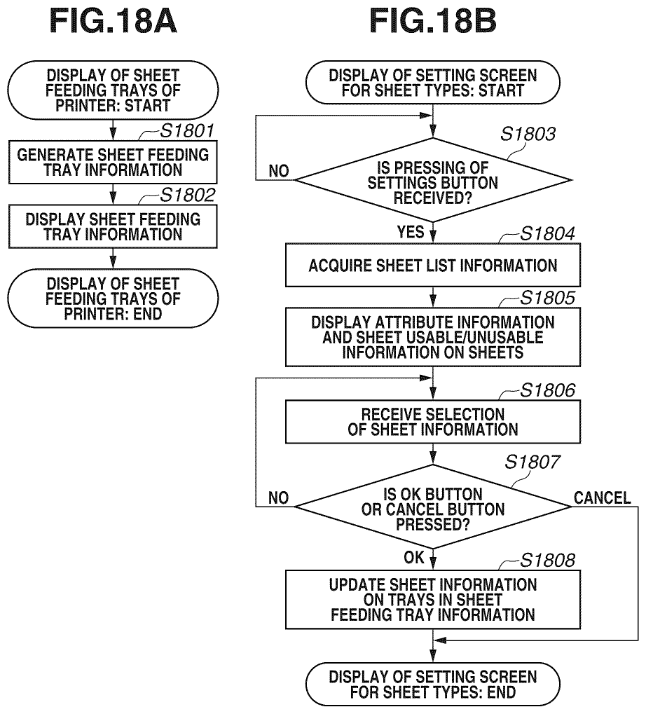

With reference to FIGS. 18A and 18B, a description is given of a process in which the controller 115 executes the setting of the sheet feeding trays 114 of the printer 101. FIGS. 18A and 18B are flowcharts of the processes of updating the sheet tray information and the sheet feeding tray information on the printer 101 according to the present exemplary embodiment.

FIG. 18A is a flowchart in which the screen 1601 for setting of sheets for the sheet feeding trays 114 is displayed on the operation unit 111 of the printer 101A according to the present exemplary embodiment. FIG. 18B is a flowchart in which the setting screen 1602 for selection of sheet types to be set for any of the sheet feeding trays 114 is displayed.

The processing procedure illustrated in FIG. 18A is executed in response to the process in step S1801 illustrated in FIG. 18A in which the controller 115 of the printer 101A receives pressing performed on a display button (not illustrated) for the sheet settings of the sheet feeding trays 114 of the printer 101.

The processes illustrated in these flowcharts are executed by the CPU 201 loading a program stored in the external storage device 208 into the RAM 202 in the controller 115.

The controller 115 receives the pressing performed on the display button (not illustrated) for the sheet settings of the sheet feeding trays 114 of the printer 101. In response to the user pressing the display button, the controller 115 executes this flowchart.

In step S1801, the controller 115 generates the sheet feeding tray information illustrated in FIG. 7C from the sheet list information on the printer 101 illustrated in FIG. 7B.

In step S1802, the controller 115 displays the sheet feeding tray information. The number of the sheet feeding tray buttons 1603 to 1608 changes depending on the information on the sheet feeding trays 114 of the printer 101. In each sheet feeding tray button, the controller 115 displays the number of the sheet feeding tray 114 and the set sheet name. The controller 115 displays the sheet feeding tray buttons 1603 to 1608 in step S1802, and then this flowchart ends.

FIG. 18B is a flowchart in which the setting screen 1602 for selection of sheet types to be set for any of the sheet feeding trays 114 is displayed.

The processing procedure of this flowchart is executed in response to the process in step S1803 in FIG. 18B in which the controller 115 receives the pressing performed on the SETTINGS button 1609 for any of the sheet feeding trays 114 of the printer 101 in FIG. 18A. In a case where the controller 115 has received pressing performed on the SETTINGS button 1609 by the user in step S1803 (YES in step S1803), the processing proceeds to step S1804. In a case where the controller 115 has not detected pressing performed on the SETTINGS button 1609 (NO in step S1803), the controller 115 waits until the SETTINGS button 1609 is pressed.

In step S1804, the controller 115 acquires the sheet list information on the printer 101 illustrated in FIG. 7B.

Next, in step S1805, the controller 115 displays the attribute information and the sheet usable/unusable information on the sheets in the area 1611 for the sheet list information. In the present exemplary embodiment, in a case where the sheet usable/unusable flag is set to “0”, more specifically, for example, the sheet usable/unusable information of “ultra-coated G” of the sheet ID “M007” in FIG. 15A is “0”, the controller 115 grays out the sheet information so that the sheet information cannot be selected. In the present exemplary embodiment, UNUSABLE 1612 is displayed in the area 1611 for the sheet list information so that the user can understand that use of the sheet is restricted by the sheet management application.

In step S1806, the controller 115 receives the selection of sheet information on a sheet that is not grayed out.

In step S1807, the controller 115 checks whether the OK button 1614 or the CANCEL button 1613 in FIG. 16B has been pressed.

In a case where the controller 115 determines that neither of the two buttons has been pressed (NO in step S1807), the processing returns to step S1806. In a case where the controller 115 determines that the OK button 1614 has been pressed (OK in step S1807), the processing proceeds to step S1808. In a case where the controller 115 determines that the CANCEL button 1613 has been pressed (CANCEL in step S1807), the controller 115 performs nothing, and this processing flowchart ends.

In step S1808, the controller 115 updates the sheet information on the trays in the sheet feeding tray information to the sheet information selected when the OK button 1614 is pressed, and this flowchart ends.

In the present exemplary embodiment, the sheet usable/unusable flag set by the sheet management application is updated to the sheet list information on the printer 101 so that the information is used on the operation unit 111 of the printer 101 in the setting of the sheet information on the sheet feeding trays 114. The update of the sheet usable/unusable flag is not limited to the update from the sheet usable/unusable flag set by the sheet management application to the sheet list information on the printer 101. Alternatively, the controller 115 may display the sheet list information on the operation unit 111 of the printer 101, and the sheet usable/unusable flag set by the sheet management application may be updated to the result of the user changing the sheet usable/unusable flag.

In the present exemplary embodiment, a printer that performs printing on a cut sheet using an electrophotographic technique has been illustrated as an example. The present disclosure is not limited to the use of the cut sheet printer using the electrophotographic technique. Also, in a cut sheet printer using an inkjet technique, a large-format printer, or a continuous form paper printer using a roll of paper, the present exemplary embodiment can be carried out by saving sheet list information including a sheet usable/unusable flag in the external storage device 308.

As described above, according to the present exemplary embodiment, the sheet usable/unusable setting information is not only held in the sheet management application, but also shared with a printer, whereby sheet information on a sheet that can be set to a sheet feeding tray can be used via an operation unit of the printer. Then, the assignment of sheet information managed by the sheet management application can be achieved by a simple operation on the operation unit of the printer.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-063253, filed Apr. 10, 2023, which is hereby incorporated by reference herein in its entirety.

What is claimed is:

1. A computer-readable storage medium storing a program for causing a computer of an information processing apparatus to execute a control method, the control method comprising:
displaying sheet information on the information processing apparatus;
causing the information processing apparatus to search for an image forming apparatus to which sheet information selected by a user from the displayed sheet information is able to be set; and
displaying the image forming apparatus found by the search on the information processing apparatus.

2. The storage medium according to claim 1, wherein the program causes the computer to set the sheet information selected by the user to a sheet holding unit of the image forming apparatus, the sheet holding unit being selected by the user.

3. The storage medium according to claim 1,
wherein the program causes the computer to cause the information processing apparatus to store information in which a plurality of image forming apparatuses is associated with sheet information that is able to be set for the plurality of image forming apparatuses, and
wherein the program causes the computer to cause the information processing apparatus to search for, based on the information, an image forming apparatus associated with sheet information on a sheet to which the sheet information selected by the user is able to be set.

4. The storage medium according to claim 1, wherein the program causes the computer to change a mode of displaying a sheet holding unit which is among a plurality of sheet holding units of the image forming apparatus found by the search and to which the sheet information selected by the user is able to be set.

5. The storage medium according to claim 4, wherein the program causes the computer to change a color of display of one of the plurality of sheet holding unit of the image forming apparatus found by the search and to which the sheet information selected by the user is able to be set.

6. A control method for controlling an information processing apparatus, the control method comprising:
displaying sheet information;
searching for an image forming apparatus to which sheet information selected by a user is able to be set; and
displaying the image forming apparatus found by the search.

7. An information processing apparatus, comprising:
a display unit configured to display sheet information;
one or more processors; and
one or more memories,
wherein the one or more processors and the one or more memories cooperating to:
search for an image forming apparatus to which sheet information selected by a user can be set; and
display the image forming apparatus found by the search on the display unit.
